(19) United States
(12) Patent Application Publication
(10) Pub. No.: US 2003/0179102 A1
(43) Pub. Date: Sep. 25, 2003

(54) System for controlling irrigation applications

(76) Inventor: Andrew Barnes, South Lyon, MI (US)

Correspondence Address: KOHN & ASSOCIATES, PLLC, Suite 410, 30500 Northwestern Highway, Farmington Hills, MI, 48334, US

(21) Appl. No.: 10/329,208

(22) Filed: Dec. 24, 2002

Related U.S. Application Data
(60) Provisional application No. 60/344,656, filed on Dec. 26, 2001.

(51) Int. Cl. H04Q 9/00; G08C 19/22

(52) U.S. Cl. 340/870.07

(57) ABSTRACT

A system for controlling an irrigation system having a monitor for remotely monitoring and communicating irrigation related information in the system, a controller in communication with the monitoring means for receiving the information, processing the information to coding functional commands, and sending the information to the irrigation system, and a decoder in communication with the controller for decoding the coded signal at specific sites in the irrigation system and performing a function based upon the signal. A method for remotely controlling an irrigation system by providing the system with irrigation related information and remotely modulating the system based upon the irrigation related information. A software program for controlling an irrigation system, the program having a CPU for running the program and an algorithm for controlling the irrigation system.

### CROSS-REFERENCE TO RELATED APPLICATIONS

This patent application claims the benefit of priority under 35 U.S.C. Section 119(e) of U.S. Provisional Application No. 60/344,656, filed Dec. 26, 2001, which is incorporated herein by reference.

### BACKGROUND OF THE INVENTION

1. FIELD OF THE INVENTION

The present invention relates to a system for controlling irrigation systems. More specifically, the present invention relates to a remote system for automatically controlling irrigation systems.

2. DESCRIPTION OF RELATED ART

The term evapotranspiration (ET) is used in the irrigation field to quantify how much water has been lost from soil through transpiration by plants. An ET value is calculated using actual meteorological data obtained from meteorology stations. The factors typically used to calculate an ET value are temperature, solar radiation, wind speed, vapor pressure or humidity, and barometric pressure. A change in one or more of these parameters can have a direct effect on the ET value used to determine when and how much to water. ET values are usually normalized to a specific type of vegetation. ET values are used in conjunction with other coefficients to determine how much water is required to replenish the water lost from the soil. Factors that affect determination of the amount of water include the following: (1) type of vegetation; (2) soil type; (3) root depth; (4) topography; (5) micro-climate; and (6) density of vegetation. These factors are explained further below.

For a particular type of vegetation, such as cool-season grass, the ET value represents the amount of water that has to be spread over the vegetation to replace the moisture lost by the natural and ongoing process of evaporation and transpiration. Accordingly, ET values are usually normalized to a specific type of plant or crop. For example, various plants require different amounts of moisture in the soil to sustain an optimal appearance and healthy growth environment. Plants that are drought-tolerant require less water than a baseline crop, such as grass, while lush plant types require more water. A crop coefficient (Kc) value is used to adjust the baseline ETo value for a particular plant type. For example, the crop coefficient Kc for shrub-type plants might be 0.5, while the Kc for cool-season grass might be 0.8. In addition, the Kc is also dependent on the time of year. That is, the Kc function is cyclic in nature, with the maximum generally occurring during the spring and the minimum during the winter.

The ability of soil to absorb and retain applied water is an important consideration in determining how much and how often to water. Sandy soils do not retain water well, so less water with more frequency is needed, or water will percolate beyond the root zone and be wasted. On the other hand, clay soils are good at retaining water, meaning more water can be applied with less frequency. In applying water, the absorption rate also needs to be taken into account to avoid water run off. Sandy soils have a high absorption rate as compared to clay soils. In the latter case, the total amount of water to apply needs to be divided into multiple watering cycles with each cycle having a relatively short watering time with a waiting time between cycles.

The root zone depth of plants to be watered must also be taken into account. If too much water is applied, the water will percolate beyond the root zone and be wasted. Root zone depth also affects the frequency of watering. A plant with a deep root zone needs less frequent but longer watering times. A plant with a shallow root zone needs more frequent but shorter watering times.

Topography is an important consideration in watering, since a steep slope will have a higher amount of run off than a shallow slope. Steeper slopes require multiple cycles with short watering times and wait times between cycles to allow penetration of the applied water into the soil.

Microclimate takes into account existing conditions immediately surrounding the area that is to be watered. These conditions can include fully or partial shaded areas, parking lot areas, park areas with trees, etc. Since shaded areas do not require as much water as sunlit areas, less water is needed. A microclimate coefficient (Kmc) value is used to adjust the baseline ETo value for a particular site.

Density of the vegetation that is to be watered is also used in determining the amount of water to be applied. As density of vegetation increases, more water will transpire from the leaf area, requiring an increase in the amount of water needed. A vegetation density coefficient (Kd) value is used to adjust the baseline ETo value for a particular plant density.

Although prior art systems have used ET computations to determine watering schedules for irrigation systems, one drawback of such system 10s has been that they have relied upon current or historical meteorological data. Consequently, an ET value for a particular site or zone can be computed that indicates water should be applied without regard for probable changes in local weather conditions. Thus, a watering schedule may be computed that applies water today without regard for a forecast of precipitation or other significant meteorological events tomorrow.

Other prior system 10s that use ET data require on-site weather stations or ET measurements, along with central or host computers to perform irrigation watering calculations. These systems are generally not cost-effective for most small landscape sites and can require on-site system operators.

For small landscapes, such as that found at a single home site, prior art practices for water management of irrigation primarily consists of automatic or manual shutoff during rain and seasonal scheduling of use.

Thus, a drawback of conventional irrigation control system 10s is the lack of capability to account for all the changing weather-related parameters (such as rainfall, temperature, solar radiation, wind speed, humidity, seasonal plant requirements, forecasts, etc.) at a cost-effective price. Use of conventional irrigation control system 10s results in a deviation from optimum watering schedules and causes either more water to be used or not enough water, which, in turn, stresses the plants.

Accordingly, a need exists for an improved irrigation control system 10 that can cost-effectively schedule watering amounts to optimize use.

Additionally, communities throughout the United States and the world share an uneasy reliance on both surface and sub-surface water supplies. Water tables are dropping more rapidly than expected, and water conservation is of utmost concern to governing officials. As population growth increases, the demand for fresh potable water also increases in most arid states. State and local governments have issued mandates regarding the use of landscape irrigation water, and are promoting the conservation and use thereof. Thus, farmers' worry there won't be enough water to feed their crops. And environmentalists worry that too little water is allowed for natural purposes. Additionally, businesses worry that a lack of water will dampen the availability of jobs.

Landscape irrigation accounts for approximately 50% of the water used externally by homeowners and businesses. According to landscape architects, most homeowners with large landscapes apply twice as much water as their lawn actually needs. This results in an enormous waste of fresh potable water needed for internal uses.

Unfortunately the major cause for over watering is the lack of irrigation information, and technology to control waste. Consequently, there are so few types of landscape irrigation controllers, other than timers. These timers do not know when it is raining, nor do they know over watering must stop. The complexity of a multi-station timer switches opening the sprinkler valves for a specific amount of time daily, are confusing and very labor consuming. The inefficiency is in the fact they deliver water based upon the time of day, regardless of the moisture levels in the soil. Timers that are expensive and inefficient wasters of water can be modified with optimal devices that measure and control the moisture level in the zones prior to watering. Moreover, it is not convenient for most ratepayers to check the moisture levels in their lawns, and strictly have relied upon timers to do so.

Since moisture probes are extremely sensitive to placement and orientation within the soil itself. Generally, moisture probes react differently to different soils, and have a low probe life of one to two years. The performance is normally at a lesser level, resulting in either over or under watering. Most soil probes do not change alternating current (AC) to direct current (DC) in order to satisfy building and safety codes.

Therefore, there is a need for an irrigation control system that does not need a timer to control landscape irrigation. There is also a greater need for a system that can measure “real-time” moisture in the soil and yet, be suited to the both post and pre-market timered landscapes. This system will be extremely responsive to small amounts of moisture changes that occur in all soil types, in all types of weather conditions. In addition, this system will have multiple placement applications for those landscapes with extreme elevations, and soil slippage, should this occur.

In an effort to overcome these problems, controllers have been developed to start and stop irrigation cycles without human intervention. These controllers send an electric current (usually 24 volt alternating current in horticultural or agricultural use) to a remote solenoid valve, causing the valve to open. Valve closure is usually affected by discontinuing the supply of electric current to the solenoid of the valve whereupon the valve is caused to close.

Most of these types of controllers are able to handle a number of valves, opening and closing them in a programmed succession for programmed times on programmed days of the week. This series of sequential valve opening and closing on specified days is generally referred to as “a program” or “an irrigation program”. Many of the known controllers are capable of storing and executing at least one irrigation program, which adds a degree of flexibility to what the controller may accomplish.

Basically these prior controllers fall into one of three categories as follows:

1. Relatively inexpensive controllers that are capable of executing an irrigation program. These controllers are not capable of changing the set irrigation program in any way to take account of differing water needs of plants occasioned by variations in meteorological conditions. Such controllers will, if the irrigation program is not regularly modified inevitably waste considerable quantities of water, since it will be programmed to supply sufficient water to serve the needs of the plant being irrigated during periods when plant demand for water is low.

Additionally, such controllers are incapable of responding to occurrence of rain periods unless coupled to some specialist sensor designed for the purpose. Whilst such sensors are known they tend to be either expensive (and consequently little used) or unreliable (and again little used). The potential to save water by in effect harvesting rainfall by discontinuing irrigations until that rainfall finds its way into the root-zone and is transpired by the plants, is lost unless the controller can be manually de-activated. When managing large numbers of such controllers, particularly over a wide area, it is generally not possible to manually de-activate them and re-activate them when irrigation should commence.

2. More expensive controllers that can alter the frequency and amount of irrigation, either up or down, as time passes in an effort to match applications to plant requirements. Such devices usually impute likely plant requirements by use of meteorological averages developed from examination of many years of meteorological records relating to the geographical area under consideration. This type of controller is an improvement upon the first described type of controller, but is still arbitrary and inflexible as it relies on averages that must inevitably waste water when the predicted conditions do not occur.

3. Expensive controllers that can either accept direct input from an automatic weather station, or accept meteorological information directly or indirectly from a remote weather station or climatic recording facility. These controllers use such information to modify a basic program so that irrigation water applications are substantially in accord with actual plant requirements. These controllers may also be activated to apply a predetermined irrigation cycle when instructed to do so by a remote software program which accepts meteorological input and maintains a water budget for the area. However, such controllers do not utilize localized rainfall measurement and consequently irrigation management depends upon rainfall information indicative of a wider area than the irrigation area. Water wastage can result. Further, these controllers must be part of a very wide network that means that over a wide area very considerable telephony or radio costs are necessarily involved.

As stated above, the systems currently available are very expensive and are targeted towards the golf and high profile large-scale markets. The commercial and residential market is virtually absent of any type of central control system. Cost is the key factor. The major irrigation manufacturers have not realized this fact. They are in the market to sell sprinklers and valves. Each has produced a simple means to network their existing controllers together. Additionally, the systems do not overcome all of the problems disclosed above.

Communication is another costly component. Again, irrigation manufacturers are in the business to sell sprinklers and valves. Networking is not their specialty. Existing irrigation central control systems use mainly three methods of communication or a combination of these methods: hardwire, telephone/modem, and radio frequency.

The most reliable method is to have a communication cable installed between each controller. This is a labor-intensive installation and usually involves special machinery. The cable is most often buried below grade and requires site restoration at the completion of the project especially if the installation is for an existing site.

The second method is telephone/modem. This method uses phone lines and modems to communicate data. In most cases the site is reached by telephone from the central computer. At the site, the data is transferred by wire or radio to the controllers. It is possible to have a phone line at each controller for communication or use cellular technology but cost is very high for thiss type of connection.

Radio frequency transmits data efficiently. However, most irrigation manufacturers still use expensive frequencies and equipment.

It would therefore be useful to develop an irrigation control system that enables more precise water control. Also, it would be useful to develop an irrigation system that can be controlled remotely with the ability to modify the irrigation system functions based upon up-to-date information received from the site of the irrigation system.

### SUMMARY OF THE INVENTION

According to the present invention, there is provided a system for controlling an irrigation system having a monitor for remotely monitoring and communicating irrigation related information in the system, a controller in communication with the monitoring means for receiving the information, processing the information to coding functional commands, and sending the information to the irrigation system, and a decoder in communication with the controller for decoding the coded signal at specific sites in the irrigation system and performing a function based upon the signal. Also provided is a method of remotely controlling an irrigation system by providing the system with irrigation related information and remotely modulating the system based on the irrigation related information. A software program for controlling an irrigation system, the program having a CPU for running the program and an algorithm for controlling the irrigation system is also provided.

### DESCRIPTION OF THE DRAWINGS

Other advantages of the present invention are readily appreciated, as the same becomes better understood by reference to the following detailed description when considered in connection with the accompanied drawings, wherein:

FIG. 1 is a block diagram depicting the system for controlling irrigation of the present invention;

FIG. 2 is a schematic for the circuitry for the system of the present invention; and

FIG. 3 is a series of figures depicting the screens associated with the on-line remote control of the present invention.

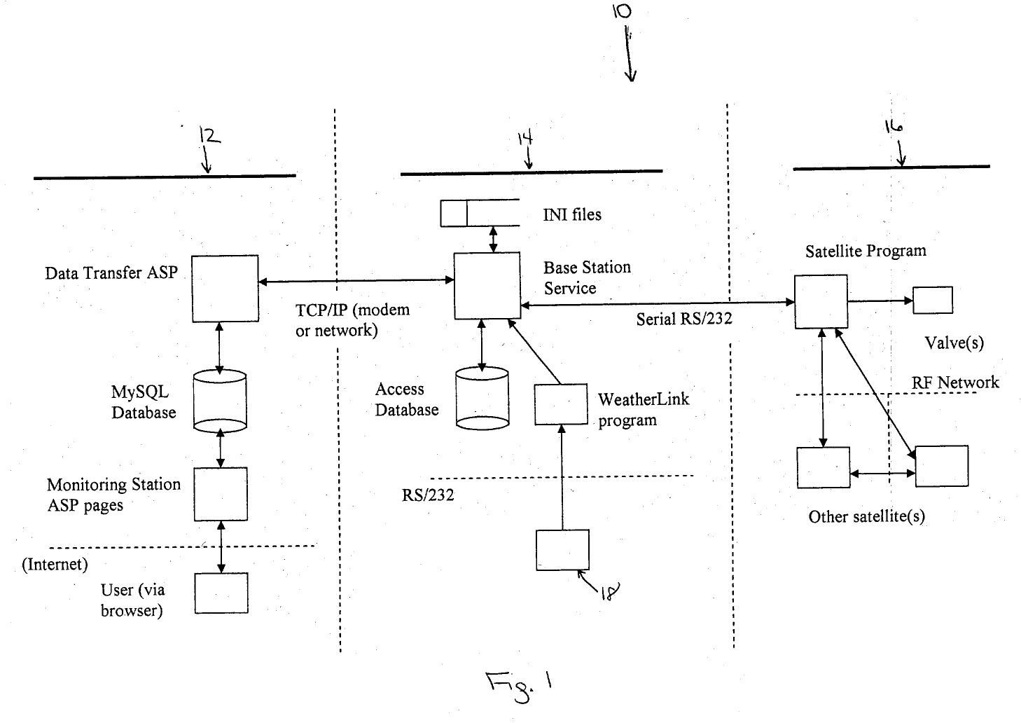

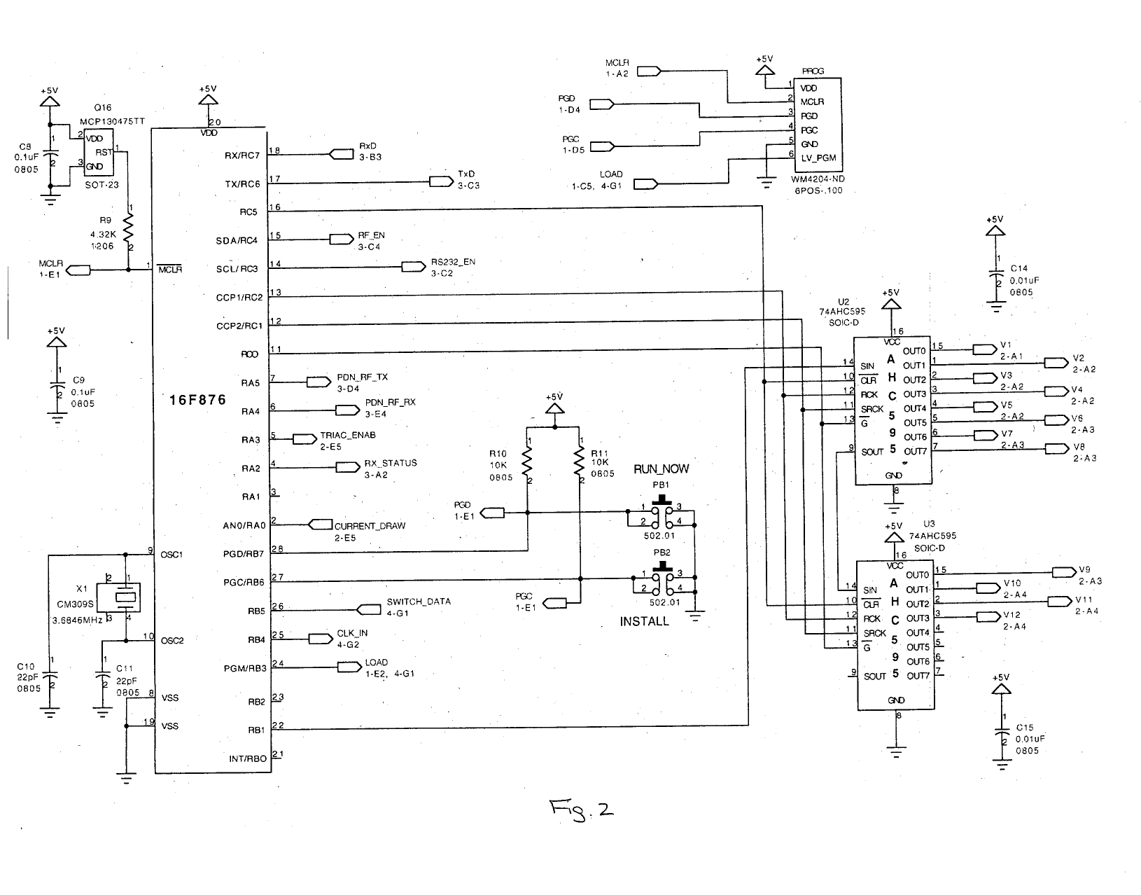

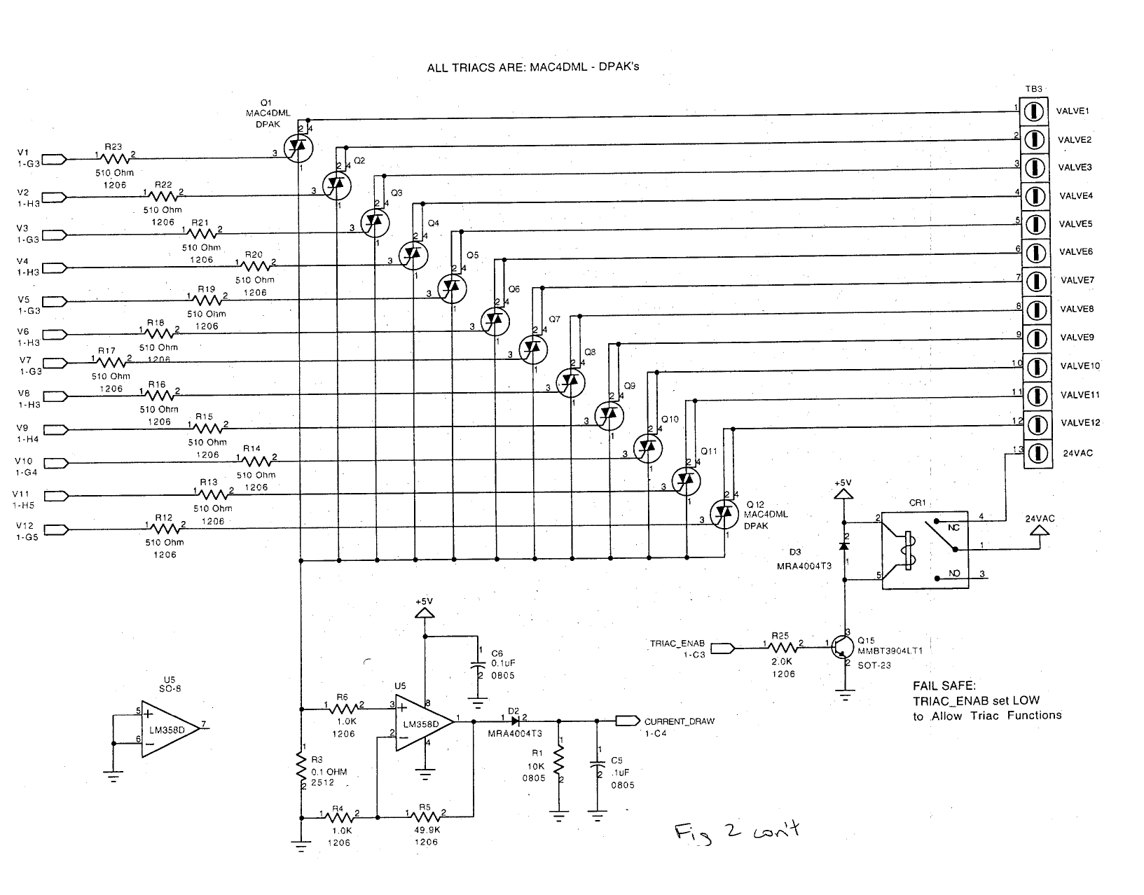

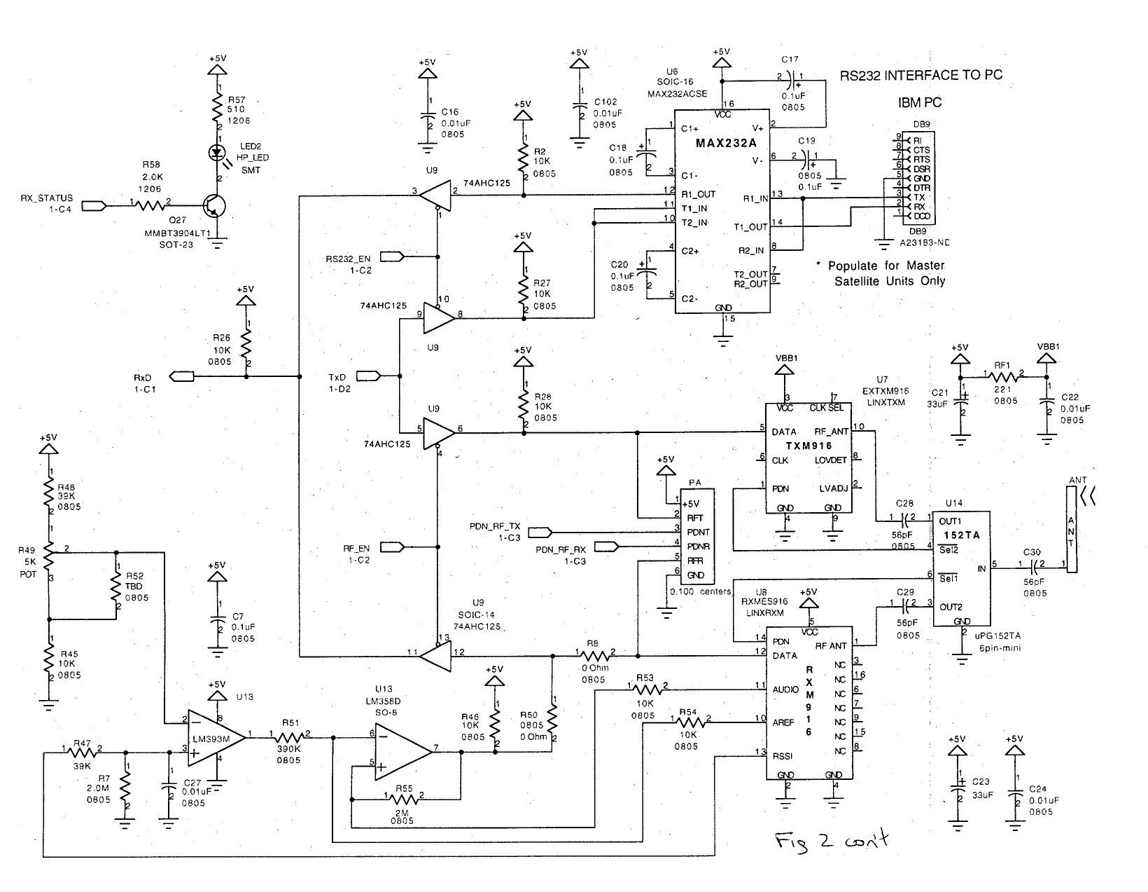

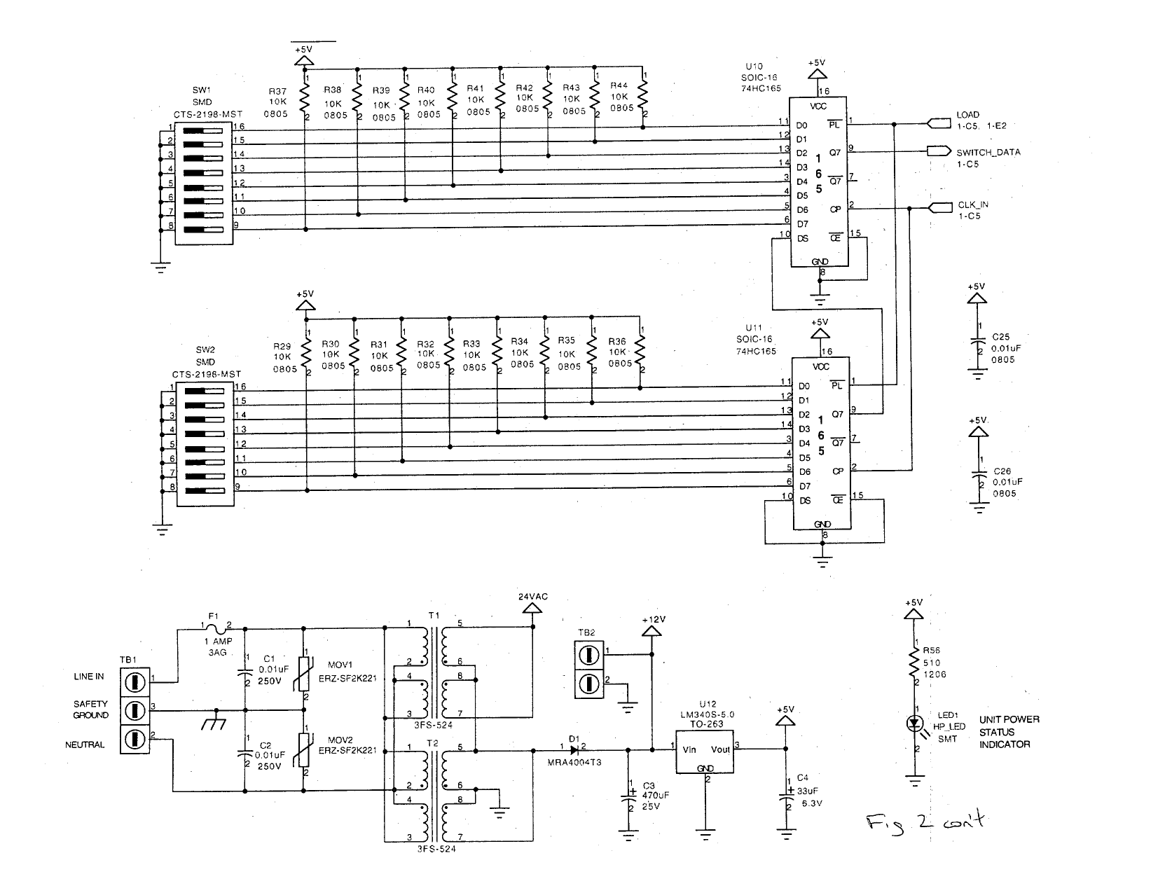

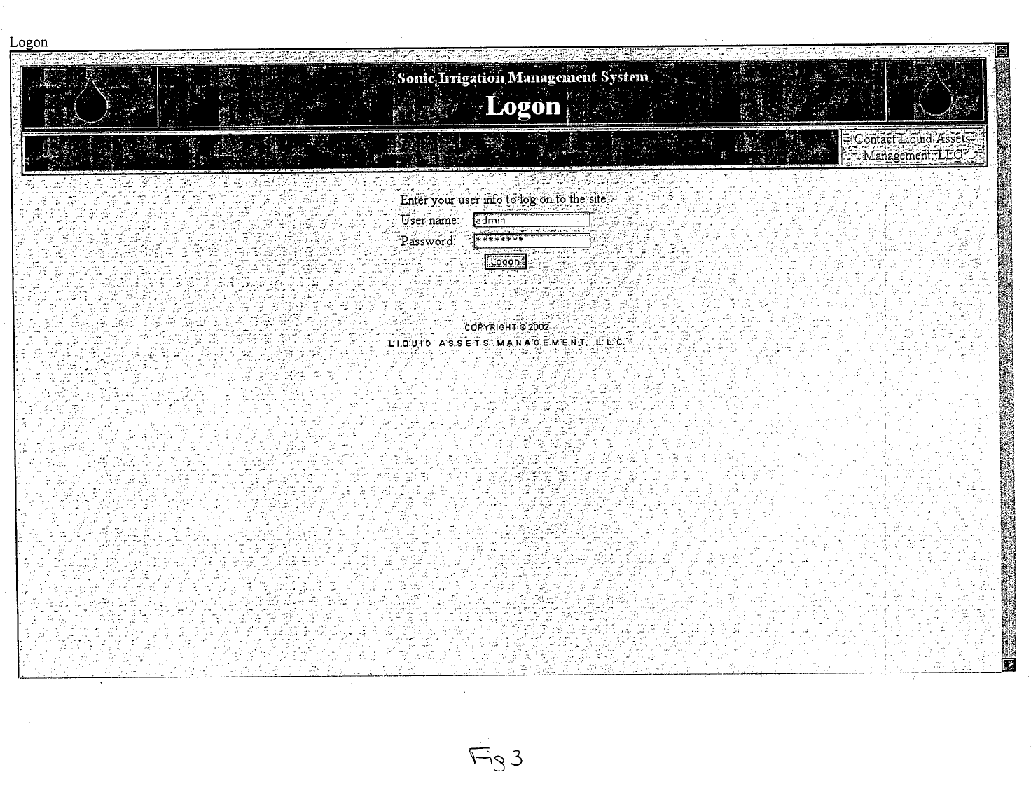

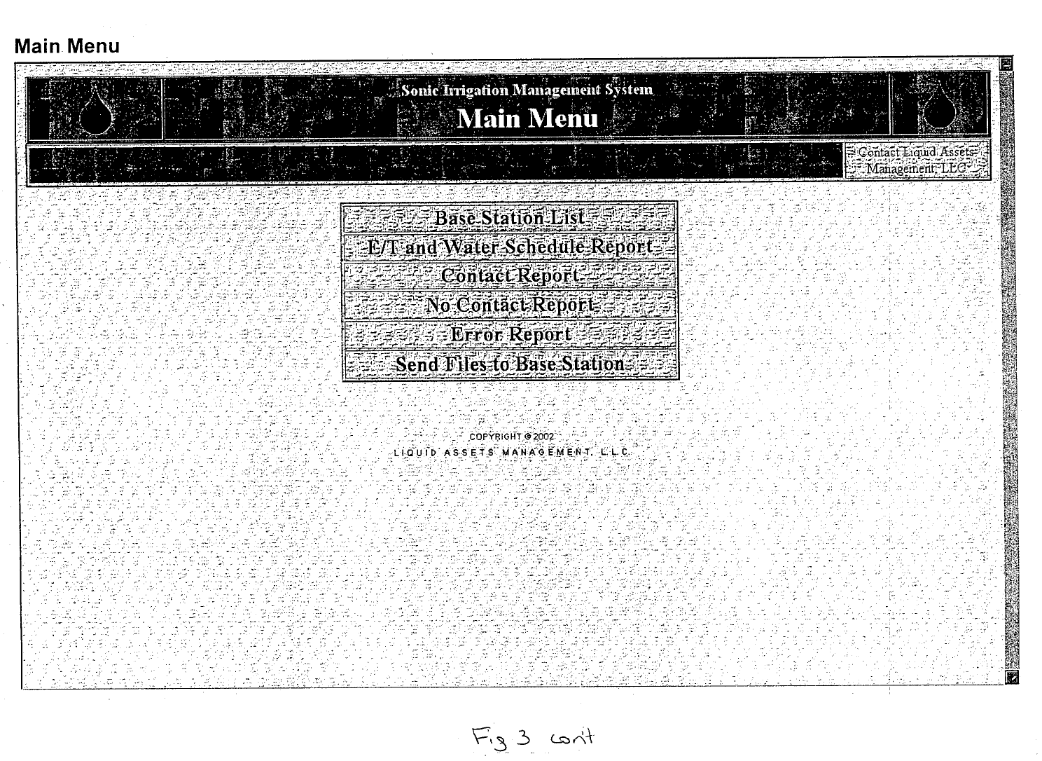

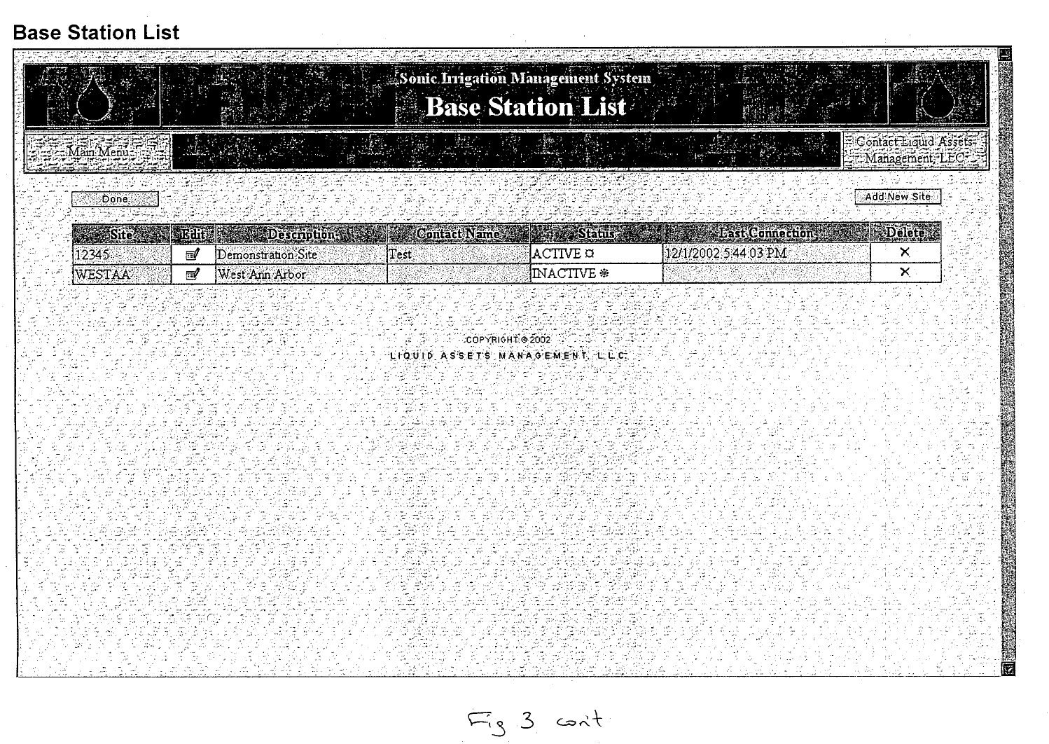

### DETAILED DESCRIPTION OF THE INVENTION

Generally, the present invention provides a method and system, generally shown at 10 in the figures, for controlling an irrigation system, generally indicated at 11. The system 10 functions by monitoring the system 10 and remotely controlling the activity of irrigation devices for the area. This system 10 enables much greater water preservation without under-watering the area. In the preferred embodiment, the system 10 functions automatically, thereby eliminating human error.

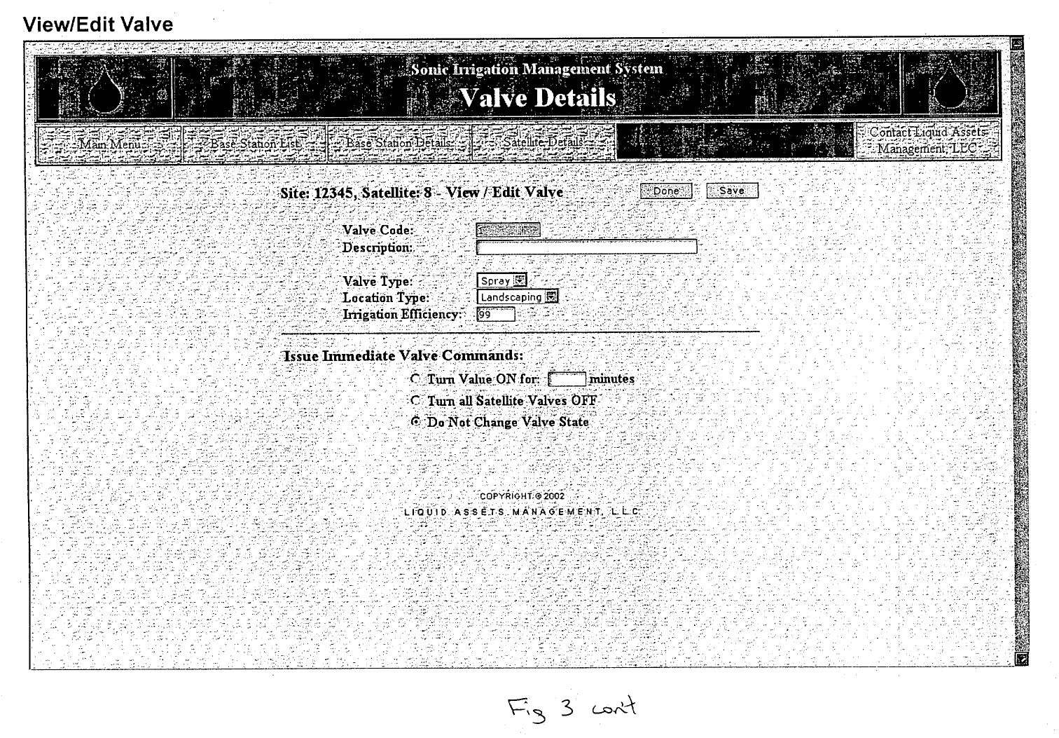

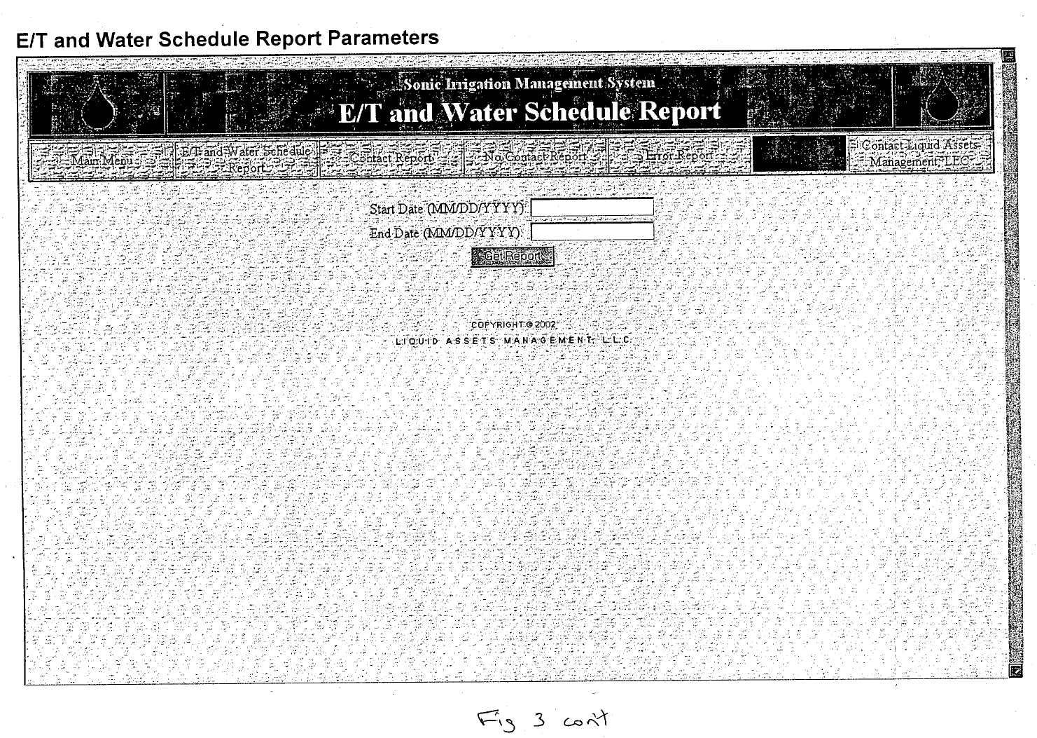

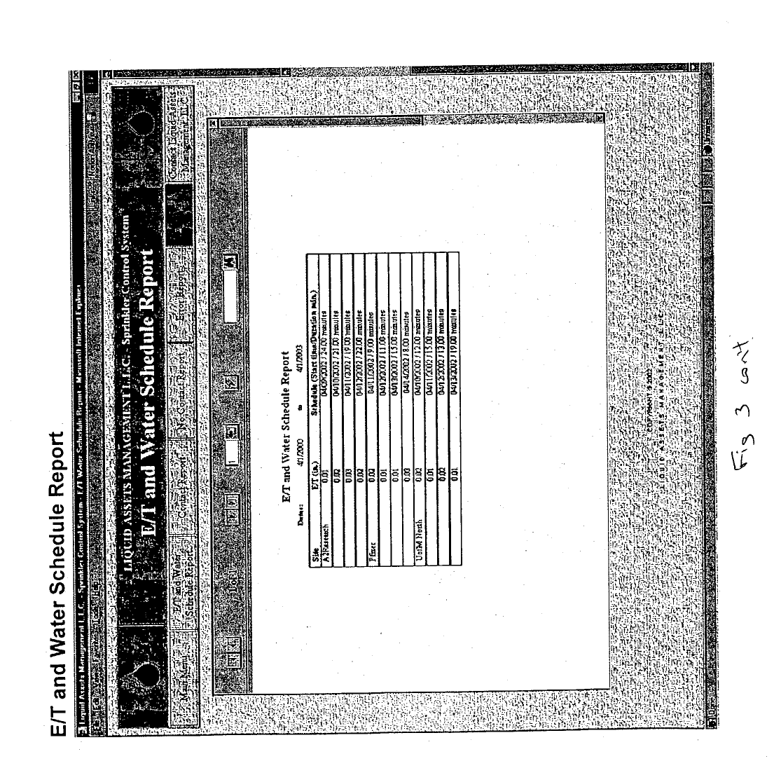

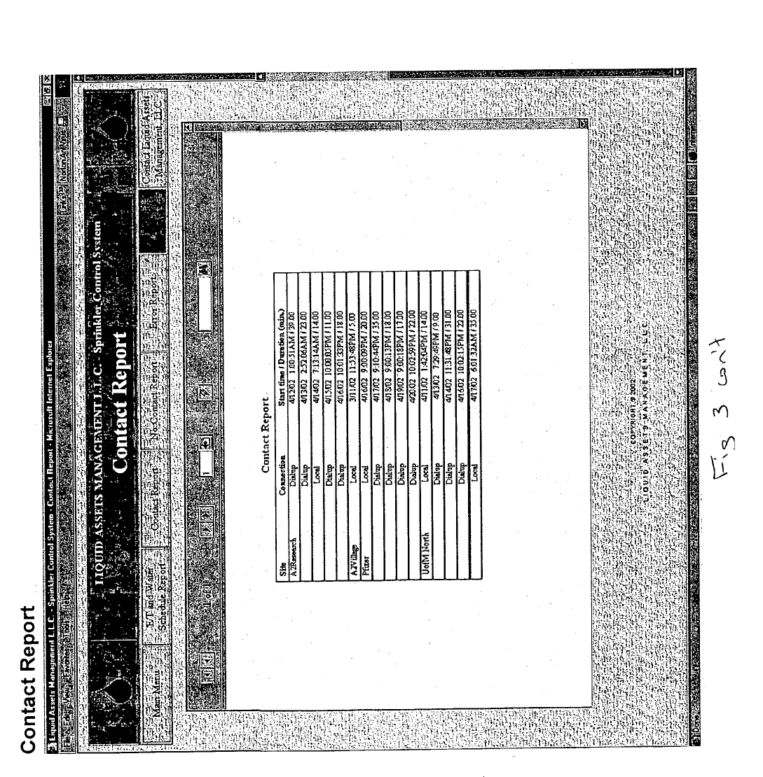

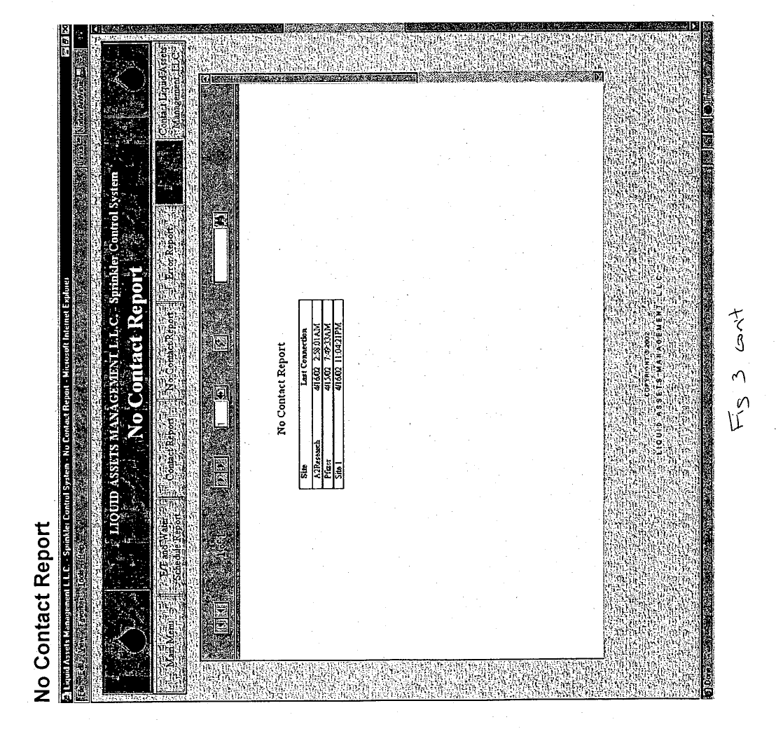

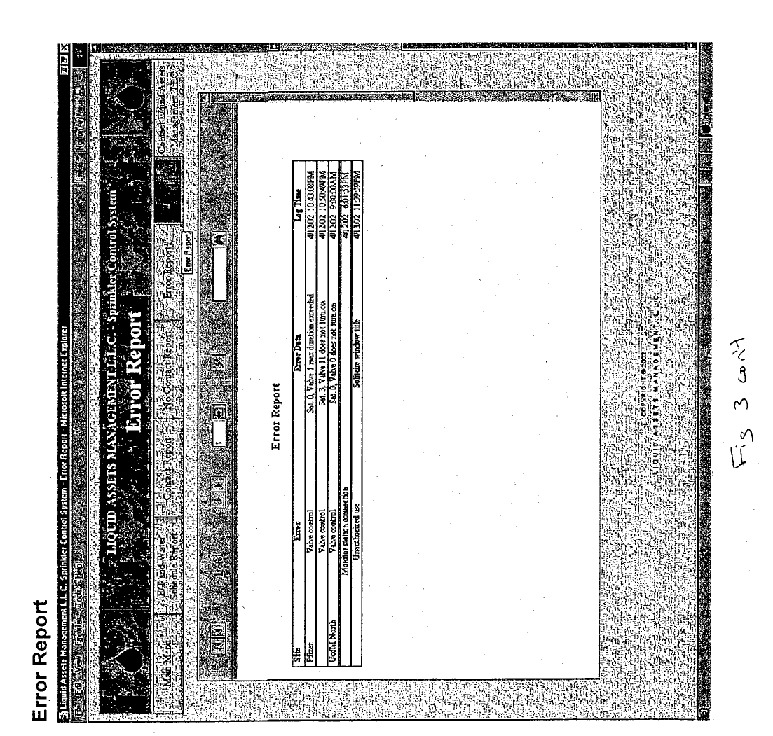

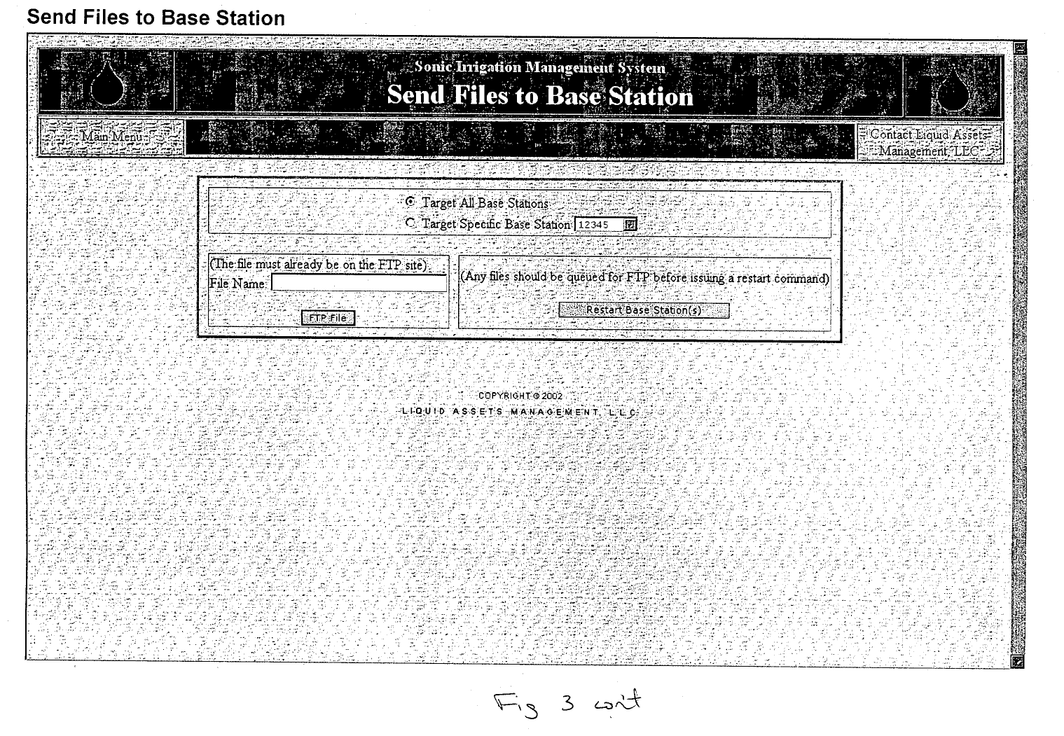

More specifically, the present invention provides a system 10 for controlling an irrigation system, the system 10 including the following components: a monitoring device 12, a controller 14, a weather station 18, and a decoder 16. The circuitry used to create the decoder 16 is shown in FIG. 3 and can include microchip technology that is known to those of skill in the art. Additionally, the software that supports the system 10 can be coded in any language that is able to function in the manner disclosed below, such languages are known to those of skill in the art.

The “monitoring device” is a device that is capable of recording, monitoring, and gathering information regarding the daily operation of the system including the weather. The monitoring station 12 is in communication with the controller 14. Preferably, the monitor 12 is in constant communication with the controller 14 via an Internet communication or LAN connection.

The “weather station” can be any weather related software or hardware that enables the system to monitor, record, and gather information regarding the weather. The weather station 18 is anything that is capable of producing a modified evapotranspiration (ET) rate. The weather station 18 is in communication with the controller 14. Weather data is sent to the monitor 12 in report form from the controller 14, subsequent to the controller 14 receiving the information from the weather station 18.

The “controller” of the present invention can be any device that is capable of receiving and processing the weather information, most importantly the amount of rainfall. However, the can instead periodically send weather information to the monitor 12 at preset intervals. The intervals can be as often or as far apart as needed. The interval can be determined by one of skill in the art. The information sent by the weather device 18 can be sent using wireless technology, radio technology, or via an Internet communication. The controller 14 can be any weather monitoring software or hardware that is available and is known to those of skill in the art. The controller 14 can also control and send messages to the decoder 16 of the present invention. Preferably, the controller 14 is a CPU that is based at the site of operation of the irrigation system 11 (i.e. a base station computer). The CPU can be accessed at the site or remotely. The remote access can be accomplished via LAN cable, wireless communications or audio communications. This communication enables access to the CPU when an individual is on site, at a remote location operatively connected to the CPU, or even via the Internet (i.e. using a modem on a computer or hand held PDA). Additionally, in a preferred embodiment, the present invention utilizes Flash technology to protect the system 10 in case of a computer malfunction.

The controller 14 of the present invention can be accessed remotely. The remote access can occur in any manner known to those of skill in the art. Example of manners of remote access include, but are not limited to, an external communication system, an internal communication system, local area network, wide area network, direct cable connection, wireless connection, and radio communications. Further, the remote access includes a security device. The security device is any method of preventing access to the system 10 absent the inclusion of an access code. The access code can be any code that can be used to access the system 10. Examples of such access codes include, but are not limited to, a PIN, an access code, a password, and a URL with an identification number.

The “decoder 16” of the present invention is a device able to decode messages received from the controller 14 and induce a function in the irrigation system 11. The decoder 17 is preferably a workstation satellite controller. Examples of functions of the decoder 16 include, but are not limited to, opening and closing valves, increasing or decreasing water pressure, changing the type of water being used for irrigation, and moving the sprinklers. The decoder 16 can also send messages to the controller 14, thus ensuring that the system 10 is functioning properly. In other words, the decoder 16 can send a message to the controller 14 that the decoder 16 is not functioning properly. In the irrigation system 11, the decoder 16 is located at valves throughout the irrigation system 11. The decoder 16 turns on and off the valves based upon the signal received from the controller 14. The opening and closing of the valves thus controls the irrigation system 11. The decoder 16 can include a 24-volt terminal block that is capable of both receiving and sending messages to the controller 14.

Messages are sent throughout the system 10 using wireless and radio technology. The message is preferably a digital transmission using communication cards for the wireless technology and other appropriate materials depending upon the type of technology being utilized. These materials are any materials known to those of skill in the art to function in the desired manner.

A flow sensor can also be included in the system 10 of the present invention. The flow sensor records the amount of water used by each zone in a sprinkler system 10 for a given time period. A comparison can be made to the recorded amount of water used in a previous cycle and the current amount required. If the computer program detects discrepancies in the amount of water being used in a particular zone it can send a message to the monitor 12 indicating a possible leak or damage. A service call can be arranged with a local contractor. Should a broken head or leak be discovered and repaired within a short period of time a considerable amount of water can be saved.

The present invention provides a simplified radio network. The amount of information that needs to be transferred is very low; so a few short signals can be used to carry more than enough data. The frequency with which the controllers 14 need to communicate is minimal, so the signals would only occur a few times per day.

More specifically, in the preferred embodiment of the present invention the system of the present invention functions as follows. A computer program maintains and identifies the onsite system 10 network. Each weather station and satellite workstation communicates directly to the onsite “base station” computer using a RS232 cable or by emitting radio frequencies. The weather station produces a modified evapotranspiration (ET) rate using the Penman-Montith formula. Using the ET rate, the base station program calculates the necessary amount of precipitation needed for each valve at each satellite workstation. The base station program monitors the lines of communication or the flow rates given by the flow sensor and notifies the monitoring computer through the Internet of any failures or discrepancies. Each address and location is read and categorized by the monitoring station program. The monitoring program has the capacity to multi-task multiple phone calls, transmit and receive data, and display and sound errors. The “base station” computer uses the Internet to connect with the monitoring station computer located offsite.

A “weather station” is able to read humidity, precipitation, solar radiation, temperature fluctuation, and wind speed. The collected information is stored within a data logger. The information is preferably transferred to the base station computer using a RS232 cable. The base station computer compiles and maintains the weather data.

“Repeaters” listen for radio information and simply “repeat” the signal around corners or through difficult areas to remote satellite workstation controllers. The repeater may only house the transceiver equipment.

The satellite workstation activates each 24V valve using a terminal strip in an identical manner as existing irrigation controllers. The satellite workstation connects to a standard 120V power source. Flash memory or similar can be installed to maintain an internal clock and house the start and stop times for each valve. Should communication or power fail, the satellite workstation can utilize a standard default program to continue operations until the failure is corrected. If rain is detected by the weather station, the current watering cycle is interrupted. The satellite workstation communicates using wireless radio technology directly to the base station computer onsite. Residential workstations can be equipped with a phone modem.

A flow sensor communicates directly to the base station computer onsite. It records and reports data collected during the irrigation cycle.

The system 10 of the present invention can be incorporated into already existing irrigation systems, and already existing systems for controlling irrigation systems.

The system 10 of the present invention can be used in a number of differing environments. For example, the system 10 can be used at existing apartment/condominium sites, corporate campuses, large commercial sites, and municipalities. The system 10 of the present invention is a Remote Automatic Irrigation Network (RAIN) System 10 using new Radio Frequency technology to locally transmit and receive daily watering instructions. The RAIN System 10 can maintain an irrigation network program from an offsite facility and offer the ability to adjust irrigation system 11s on a daily event to supplement current weather conditions or to promote water conservation. The service promotes significant water savings through conservation and reduces infield labor costs for its customers.

The system 10 functions as follows. Daily watering requirements for turf grass and landscaping are determined by recording the changing weather conditions. Temperature fluctuations, natural precipitation, humidity, solar radiation and wind speed is measured using an onsite weather station. This data is stored in a data logger until called upon by the onsite server “base station” computer. Generally only one weather station per site is required. If the site is large, several “micro climates” may exist. Should very precise data be required, multiple weather stations maybe installed on one site. The weather station determines an exact evapotranspiration rate. Evapotranspiration (ET) is the measure of the ability of the atmosphere to remove water from the earth's surface through the processes of evaporation and transpiration. The “base station” computer program reads the ET rate provided by the onsite weather station and determines the exact amount of water required to irrigate time turf grass or landscaping for a determined area. If weather conditions indicate the amount of water found through natural precipitation is below the required amount to grow turf grass the difference is equalized through the addition of irrigation. If the amount of water exceeds the determined limit for turf grass, irrigation is withheld. A command signal is sent to each valve by transmitting a radio signal from the onsite server “base station” computer to individual satellite workstation controllers throughout the site. Each satellite workstation controller 14 receives instructions to open and close each valve based on the information processed by the base computer. By altering time amount of water that is applied through the irrigation system 11, the turf grass only receives the proper amount of water and wasted water is greatly reduced. The signal sent from the onsite server “base station” computer is transmitted via a radio signal using a true network protocol. This signal does not require a direct line of site to communicate. It transmits over solid objects or around objects through the use of repeaters. The base station computer program can ran automatically and can constantly read the weather station and change the amount of time programmed to irrigate each area every 24 hours. Each satellite workstation controller 14 is given an identifying address ensuring the correct watering times reach the correct controller 14 and irrigation valve. The amount of time allowed to irrigate can fluctuate daily as weather conditions permit Default system 10s are engineered into each satellite workstation to protect from watering too much or not watering at all. The program can be instructed to comply with local water restrictions if imposed such as odd-even watering day requirements. The user may also choose to conserve additional water by shaving off time beyond the required amount of precipitation calculated by the computer program using a global percentage system 10. By restricting the amount of water applied to the turf grass, the rate of growth may be limited to reduce the frequency of mowing. Only the necessary or desired amount of water is used. Wasted water is drastically reduced.

A single monitoring station computer is maintained at an offsite location. This monitoring computer receives regular updates from each client system 10 that is installed in the field. The computer maintains a summary database of system 10 start times, durations, and gallons of water used for later reporting and analysis. It also handles time automatic distribution of software updates back to the client system 10s as needed. The monitoring station computer maintains a dedicated Internet connection, with the bandwidth and processing power required depending on the total number of client systems in use at any given time. The monitoring station computer maintains a list of active clients, and routinely checks to ensure that it has received information from each client within the past 24 hours. The software alerts a user if the system 10 has not reported in within that time. Onsite “base station” computers are responsible for detecting specific problems and events (loss of contact with a satellite-controller 14, rain starts or stops, the temperature dips to near freezing, etc.), as well as, watching for specific “unlikely conditions” (i.e., continuous sun for more than 10 hours, continuous or constant wind, etc.) that can indicate a failure on the weather station. It communicates those events to the monitoring station computer as well, which in turn alerts the user. Communication between the local “base station” computers and the monitoring computer can be performed via the Internet. Each “base station” computer is enabled with a dial-up modem and Internet connection that it can use to establish a communication session via a 1-800 number with the monitoring computer. The communication session is estimated to last less then one minute in length for each “base station” computer. The monitoring computer can modify the time and frequency of each call. The monitoring computer is able to communicate with one or more local “base station” computers simultaneously.

Components needed to be installed at each site are the required number of satellite workstation controllers (generally 3 to 4 units), one weather station and a base station computer. All components must communicate onsite using radio network technology.

A computer server and an Internet service provider can be used to access the RAIN Systems. RAIN Systems can also be accessed onsite using a laptop computer and a local area network card. Instructions can immediately be implemented for demonstration or trouble shooting practices.

The possibility does exists to expand and create an Internet monitoring site that would collect weather data and determine the scheduling numbers to send out to specific homeowners automatically. Once established, a network of weather stations can constantly send in data regularly for monitoring. The Internet website and weather station networks can be run by individual companies licensed to offer monitoring services.

Communities with homeowners associations can install and share a single weather station or download data from weather stations within close proximity. Each house can be outfitted with a satellite workstation controller 14 and would call a local dial up number to gain connection to the Internet The outgoing call would be placed late at night Once a connection is made the monitoring program downloads the irrigation schedule based on the weather information gathered from the nearby weather station. Water authorities themselves could be licensed to purchase the monitoring system 10 and maintain a dial-up program. The program runs automatically and continuously via the World Wide Web. Each workstation at each house receives data every 24 hours updating how much water is to be used based on the weather conditions nearby. The homeowner simply pays a monthly fee to have their sprinklers monitored offsite. Sprinkler systems use the correct amount of water. Municipalities also can have the ability to restrict watering to odd even dates or activate the sprinkler systems during off peak hours or require homeowners to participate in the monitoring program.

With multiple scientific weather stations throughout a geological area the data collected can be logged and offered to meteorologists and farm organizations for a fee. The software allows independent third party access to the weather information without sacrificing security protocols.

While the systems of the prior art network stand-alone controllers with like controllers or “servers” with “servers”. The present invention instead simply waits and sends someone to fix the connection if it becomes severed. The satellite workstation controller 14 is built as a “slave” to the onsite “base station” computer the “server”. The satellite workstation is equipped with a small amount of memory to activate a default program should communication to the central be lost. This can be done without incurring a tremendous cost. The key to the default program is that it cannot be changed or imputed on site by a user. The central computer program discovers the severed link and notifies the monitoring personal. Meanwhile the default program activates and instructs the satellite “workstation” to irrigate using only a modest amount of time until the link can be reestablished. Human intervention is necessary to perform the service call but the lawns remain green until this can be done. Additionally the default program ensures the valve turns off on command.

### EXAMPLES

### Examples 1

The monitoring station is installed on a single host server with an “always-on” connection to the Internet. The software runs as a standard web site, under a single base URL and IP address as shown in FIG. 3. It has two primary interfaces (i.e., top-level pages),one for automatic communications (used by the Base Stations) and one for manual use (accessed as a standard web page via a browser).

Data Transfer Asp

This set of ASP pages handles communication between the Monitoring Station and the Base Station(s). When a Base Station initiates contact with the Monitoring Station, it requests the appropriate ASP page, which handles the conversation on the Monitoring Station's side. These pages collect the information reported by the Base Station and send down instructions generated by the user (if any exist).

MySQL Database

This is the central data repository for the system 10. It includes information about all Base Stations in its network, including information collected from them.

Monitoring Station ASP Pages

This set of ASP pages allows the system-level user to directly interact with the Monitoring Station, to set up or edit information about a Base Stations, error logs, etc. All user-level Monitoring Station features are accessible through this interface.

User (via Browser)

The site was written to be compatible with IE 5.0. It uses standard Internet protocols (HTTP) to communicate with the browser.

Base Station

The Base Station was designed to reside on a computer at the individual client sites (i.e., a location with an irrigation system 11). The station requires a dial-up or always-on connection to the Internet that can be automated using MS Windows' standard IE setup. The Base Station must also include a network port to be used for local control, a serial port for connection to the weather station, a serial port for connection to a satellite, and a serial port for the modem (if one is used).

TCP/IP (modem or Network)

To connect to the Monitoring Station, the Base Station triggers Windows to establish an Internet connection, which in turn dials the modem. Once connected, the Base Station attempts to connect to the Monitoring Station's IP address and requests the proper ASP page(s) to send and receive information. This normally happens on a periodic interval as per the specification. However, when the small application BaseStationWakeup.EXE is run on a laptop connected to the base station via the local network, it ignores this interval and attempts to maintain an active connection with the Monitoring Station.

INI Files

The two INI files, BaseStation.INI and BaseStationID.INI, are used to set the configurable information about the base station. This includes the Monitoring Station IP address and the Base Station ID

Base Station Service

The Base Station application, written in C++, handles all requirements of the Base Station, including communicating with the weather station, primary satellite, and the Monitoring Station.

Access Database

The local database, using MS Access, stores operational information about the site temporarily. It is used as a “staging area” for information that is to be uploaded to, or that is received from, the Monitoring Station.

WeatherLink Program

This is a separate application installed as per the manufacturer's instructions. It gathers information from the weather station and makes it available to the Base Station Service.

RS/232 Connection

The weather station connects to the base station through a standard serial port. This is configured using the WeatherLink program.

Weather Station

This must be an identical weather station to that discussed above.

Satellite Program

The satellite program, which is written in C, runs on each satellite. The program is identical, although DIP switches are used to configure the satellites as to their unique ID numbers, whether they are connected to the base station directly, and whether they are the “parent” for one or more other satellites.

Serial RS/232

The satellite program can send and receive messages via a standard serial connection directly from the Base Station. These messages are identical to messages received via RF, except that the satellites assume that any serial communication must be directly with the single Base Station.

Satellite Program

The satellite program handles all of the required satellite behaviors, including sending, receiving, and relaying messages, calculating watering schedules, applying coefficients, and so forth.

Valve(s)

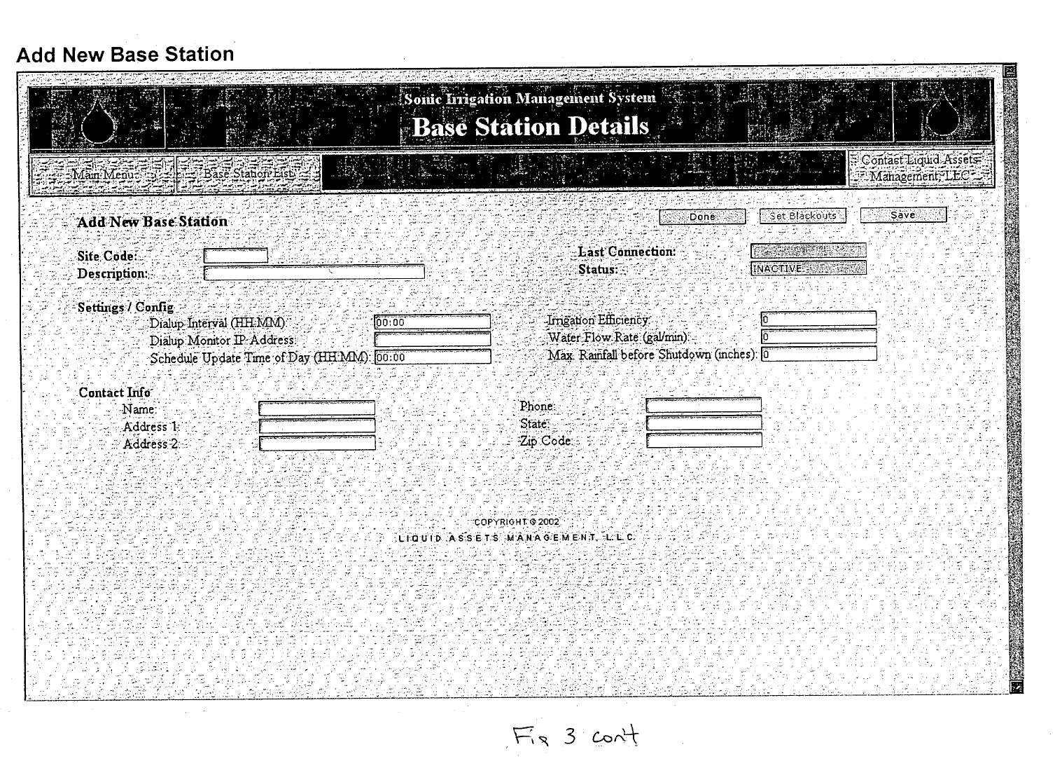

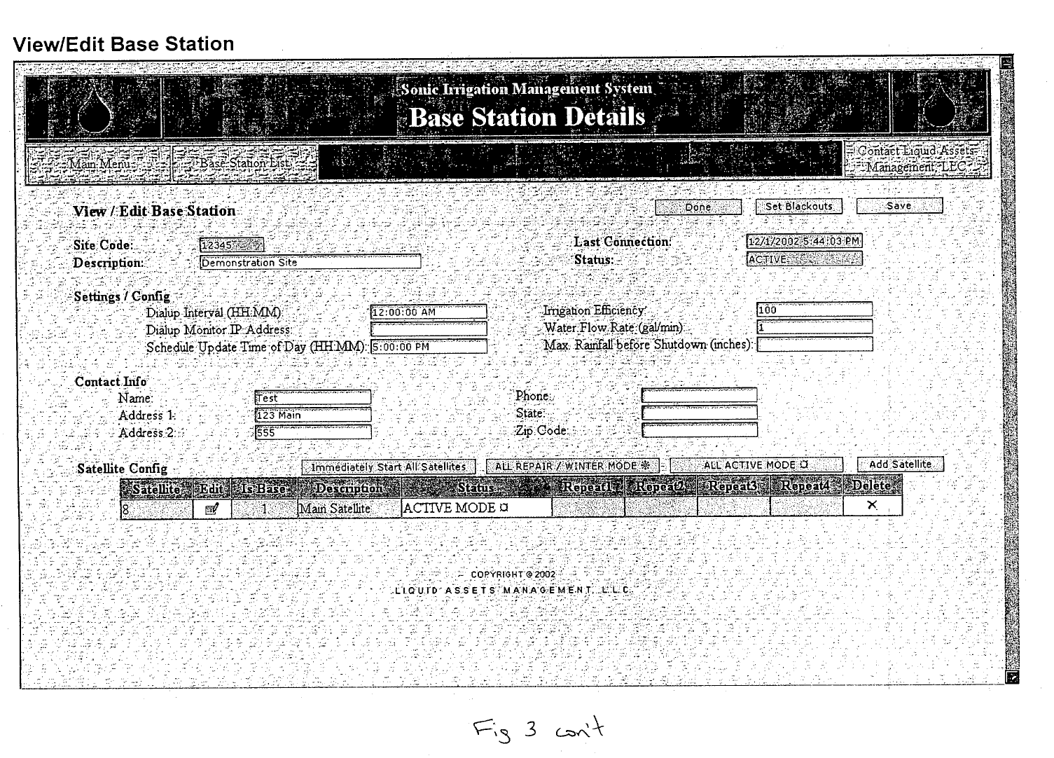

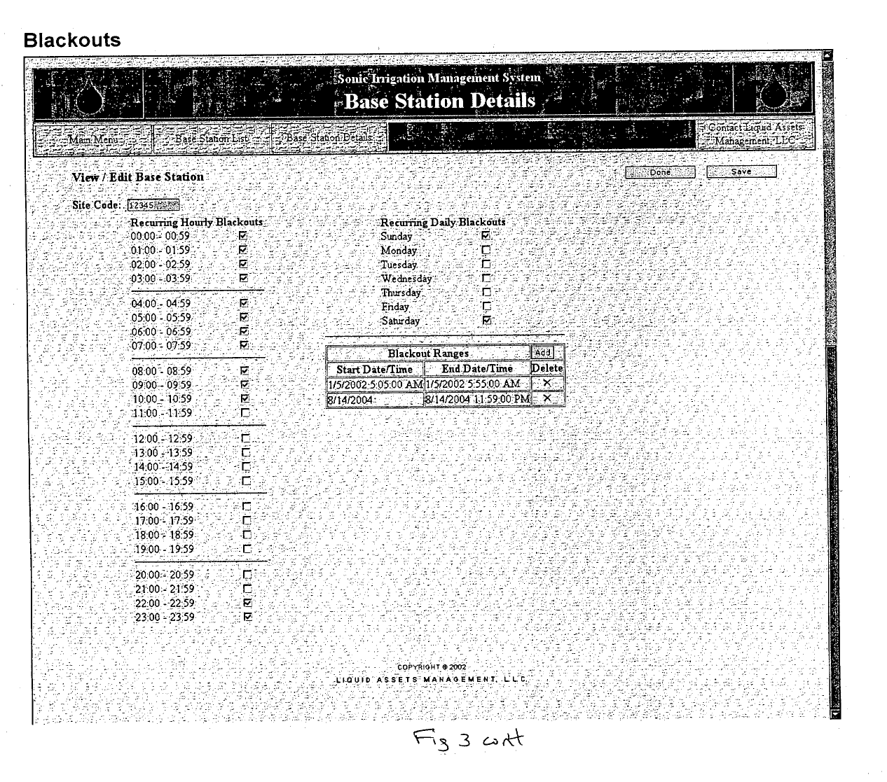

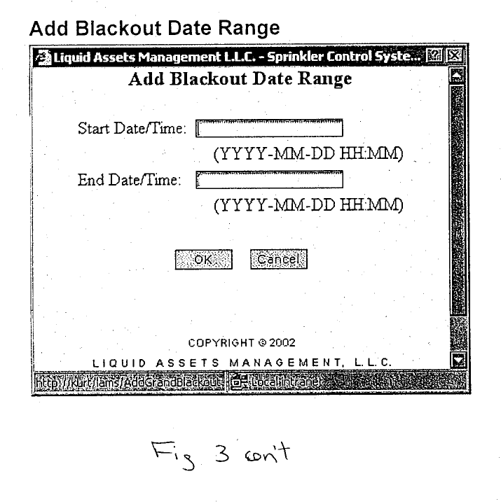

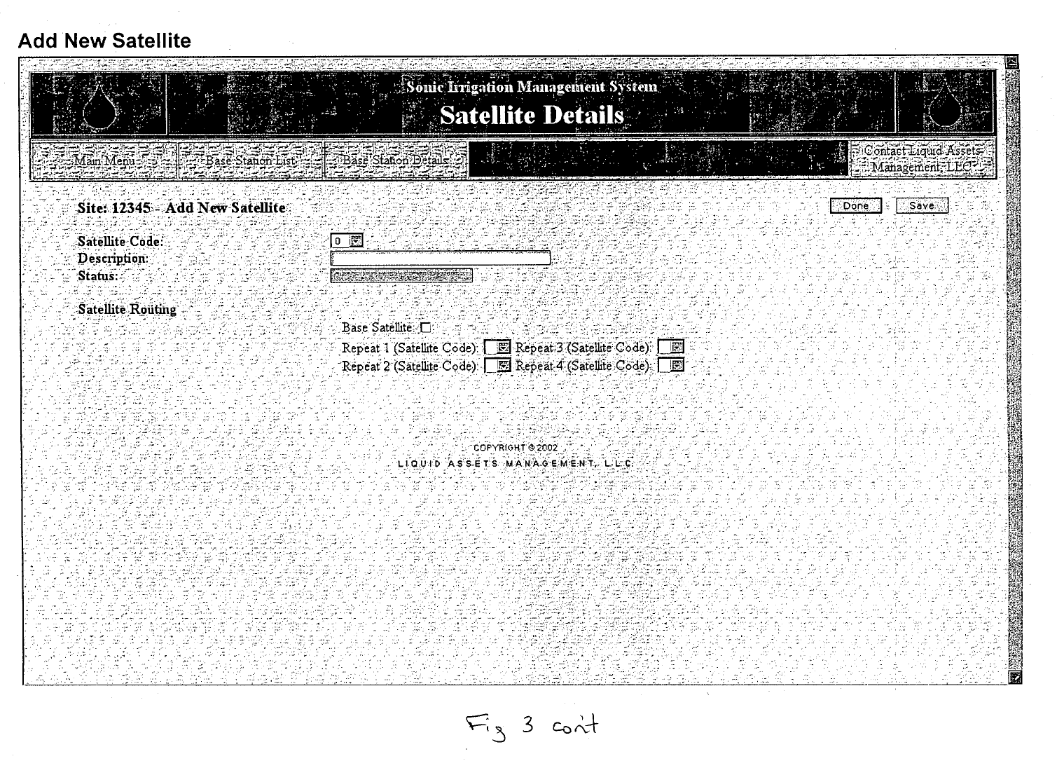

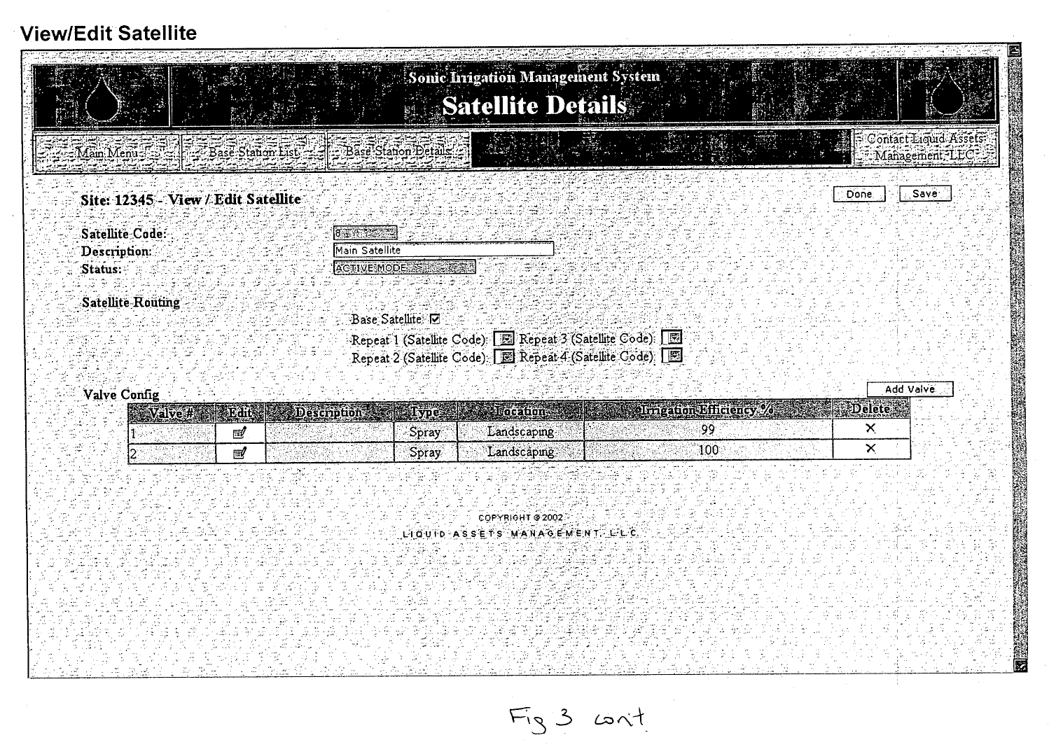

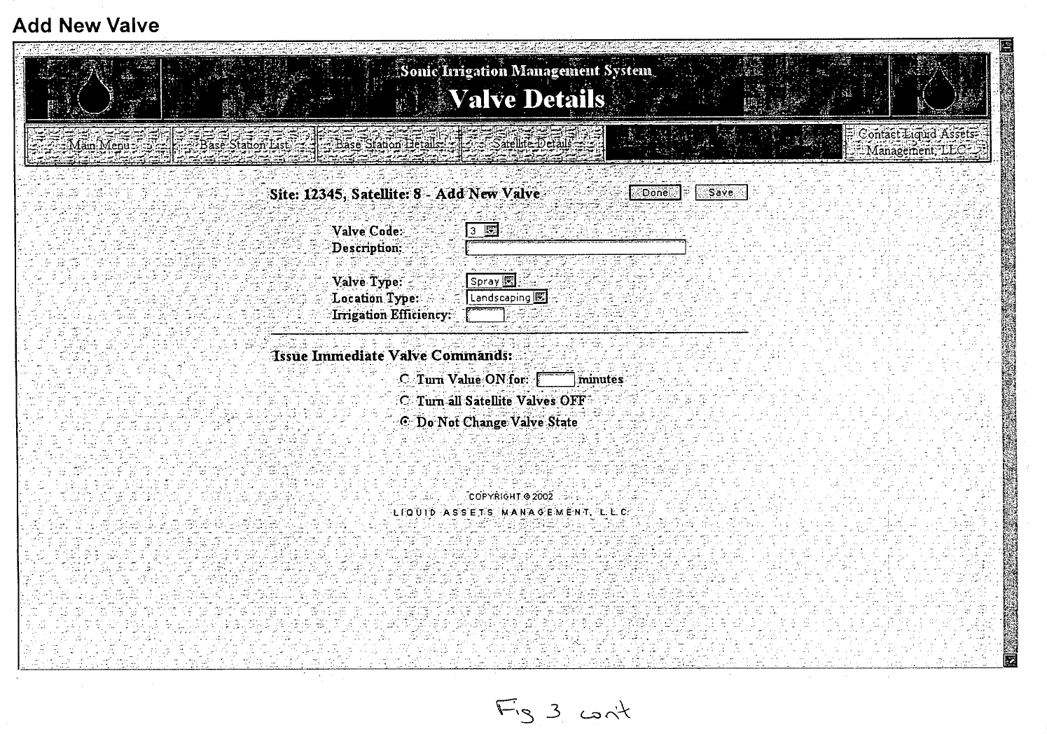

Valves are hard-wired to the satellite controllers. The circuitry is found in FIG. 2.

RF Network

The RF network allows each satellite the ability to send messages to and receive them from other satellites. Messages are targeted (i.e., sent on a specific satellite rather than broadcast to a group) and can be forwarded from one satellite to another to overcome range limitations.

Other Satellite(s)

The site must have at least one satellite connected via serial to the base station. The site can also have one or more additional satellites, up to the maximum quantity, that communicate with the system 10 exclusively via RF.

### Example 2

Installation Process

Install the Monitoring Station. The Monitoring Station should be running and connected to the Internet before proceeding to the following steps. Install a proper version of Crystal Reports. Version 8.5 Professional was used in the testing and development of the site.

Run the MySQL.sql script to setup the MySQL database.

Create an ODBC DSN to the database.

Create a virtual directory or web site for the web site files. The files in the “Virtual Directory” folder of the Liquid Assets source code should be put at the root of the web site or virtual directory. Be sure to allow parent paths since the pages use server side includes to the files in the “Include” and “CustomInclude” source code folders as well.

Modify the “DatabaseConstants.asp” file in the “Custominclude” folder. Specifically, change the “database_connection_string” constant to use the right DSN, MySQL user name, and MySQL password.

Modify the “Security.asp” file in the “Include” folder to setup the ADMIN_USER_NAME and ADMIN_PASSWORD constants to the desired values for the Logon.asp page to check against.

Modify the “PageHeaderStart.html” file in the “CustomInclude” folder to setup the title shown on the top of each page. This is currently set to “Sonic Irrigation Management System” and should be changed to reflect any new name.

Modify the “ButtonBarEnd.html” file in the “CustomInclude” folder to setup the e-mail address to be used when users select the “Contact Liquid Assets Management, LLC” button.

Modify the “BodyEnd.html” file in the “CustomInclude” folder to reflect any desired copyright notices.

Optional Use with Hosted Monitoring Station

One possible way to use the system 10 with a Monitoring Station hosted at a permanent web-hosting center instead of on the laptop is outlined below. Note that this setup would note require the laptop to be configured as a Monitoring Station with IIS and MySQL.

Prior to going to the field, install Windows NetMeeting on the Base Station being sure to configure NetMeeting to require security on incoming calls. Install NetMeeting on the laptop as well, but do not configure it to accept incoming calls.

The Base Station's BaseStation.INI file's remote_monitor_address and local_monitor_address can be configured such that both reference the hosted Monitoring Station.

The system 10 can be tested by connecting the laptop and the Base Station to a small network Hub and using NetMeeting from the laptop and tested as follows.

Using the same version of Internet Explorer as on the Base Station, connect to the hosted Monitoring Station and observe the title of the Internet Explorer window. Modify the contents of the BaseStation.mdb's AllowedWindow table to include this title.

Once in the field, do the following. Connect the laptop and the Base Station to a small network Hub.

Start NetMeeting on the laptop and connect to the desktop of the Base Station.

Once on the desktop of the Base Station, use the Base Station's Internet Explorer (via the NetMeeting window on the laptop) to dialup the Internet and connect to the hosted Monitoring Station.

On the laptop, start the BaseStationWakeup.exe program. Use the Base Station's Internet Explorer to configure the Base Station. When done, stop the BaseStationWakeup.exe program on the laptop. Then, close the Base Station's Internet Explorer and dialup connection. Finally, logout of the Base Station followed by closing NetMeeting and disconnecting the network.

Install the Base Station. Set the Microsoft networking name of the Base Station computer to “Lamsbasestation” (without the quotes of course). Without this, the laptop would not be able to find the Base Station. This name should always be the same no matter how many base stations are distributed to sites.

Also, setup the IP address of the Base Station computer to a fixed IP address compatible with the subdomain of the laptop. For maintenance purposes, it would likely be best to configure each Base Station with the same IP address.

Connect the Base Station to a small network Hub and confirm that when the laptop is also attached to this Hub, the laptop can use Microsoft-networking to find the Base Station computer on the network.

Ensure that a suitable modem and 2 serial (also called “RS-232” or “COMM” ports) ports are physically available on the computer. On some computers, due to hardware issues, it may not be possible to actually use the modem and 2 serials ports even though they are physically present. In this situation, a “Dual Port Serial Adapter” card will need to be installed.

Connect the Satellite to the COM1 port. Place the following files into a single directory on the Base Station:

∘ BaseStationService.exe

∘ BaseStation.mdb

∘ UpdateAssistant.exe

∘ BaseStation.INI

∘ BaseStationID.INI

Under this directory, create a folder called FTPDownloads. Make sure none of the above files are marked read-only.

Use Internet Explorer to configure a dial-up connection. Be sure to set this is as the default setup. Internet Explorer 5.5's “Tools I Internet Options” menu option and the resulting “Connections” tab can be used for this. Be absolutely certain to test this connection using Internet Explorer before continuing.

Install the weather station software and configure it to write its log file hourly. Note the location of the log file and the program file named WeatherLink52.exe. Be sure to test the connection to the weather station using the weather station's provided software before continuing.

Create a “System 10” ODBC DSN named LiquidAssetsBaseStation and point it at the BaseStation.mdb file.

Review the following sections about the BaseStation.INI and BaseStationID.INI and modify them accordingly. Run the BaseStationService.exe file with a command line switch of -i to install it as a service. For example: BaseStationService.exe -i.

Configure any desired Windows passwords. Use the Control Panel to configure the service named “LABaseStation” and configure it to run under an account with Administrative privileges. Remember to configure the password used by the service. Also, ensure the service is configured to start automatically.

Reboot the Base Station. There is no need to login to Windows to make the system 10 function.

BaseStationID.INI FILE

This INI file is used to set the site identification of the Base Station. The ID set in this should match that assigned using the Monitoring Station's “Add Base Station” screen. A sample INI is shown below. Modify the “site_code” setting accordingly.

[Configuration Information]

site_code=12345

BaseStation.INI FILE

This INI file is used for connectivity settings to other system 10s. It is likely that this file would be the same for each and every Base Station. A sample INI is shown below as is a table of field details.

[Configuration Information]

ftp_url=ftp://66.89.10.244

ftp_server=66.89.10.244

ftp_user=lams

ftp_password=password

remote monitor_address=127.0.0.1

local_monitor_address=127.0.0.1

monitor_transfer_page=/LAMS/Transfer.asp

db_connection_string=DSN=LiquidAssetsBaseStation

weather_log_file=C:\Program Files\WeatherLink\download.log

weather_link_path=C:\Program Files\WeatherLink\WeatherLink52.exe

| Field | Description |
|---|---|
| ftp_url | The URL to the FTP server containing update files. |
| ftp_server | The IP address of the FTP server containing update |
| | files. |
| ftp_user | The FTP user name to be used when downloading |
| | files. |
| ftp_password | The FTP password to be used when downloading files. |
| Remote_monitor 12_address | The IP address of the monitoring station to be |
| | contacted during dialup connections. |
| local_monitor 12_address | The IP address of the monitoring station to be |
| | contacted during local connections. |
| Monitor 12_transfer_page | The page on the Monitoring Station used to exchange |
| | data between the Base Station and the Monitoring |
| | Station. This will likely be a path to the Transfer.asp |
| | page and should not include the server address. |
| db_connection_string | An ODBC connection string to the BaseStation.mdb |
| | file. |
| Weather_log_file | The full path and file name of the log file generated by |
| | the weather station software. |
| Weather_link_path | The full path and file name of the program (EXE) that is |
| | the weather station software. |

The Base Station software runs as a Windows service that means that the software does not require user input or even for a user to log into the computer in order to operate once setup. Thus, the Base Station software does not require a keyboard or monitor 12. Windows login security is relied upon to prevent users from accessing the system 10 without a password.

The Base Station hardware should contain a network card. This network card should be connected to a small Hub (a piece of network hardware that allows two computers to be physically connected on the network). The laptop should then be connected to this Hub.

The laptop user can immediately start all Satellites, which run their last known irrigation schedule. Also the laptop user can activate a single valve at a single Satellite for a specified period of time. The laptop uses the Monitoring Station's “View/Edit Base Station” screen's “Immediately Start All Satellites” button to accomplish the first part of this requirement. The laptop uses the Monitoring Station's “View/Edit Valve” screens “Turn Valve On” option for the second part of this requirement.

The Satellites send “Valve Connection Change from Satellite” messages to the Base Station that are then stored into an error table in an Access database. The contents of this table are then sent to the Monitoring Station during the next communication with it.

An interface is set up with a Weather Station program to capture weather information on a daily basis at a configurable time. That information can be used to calculate a daily E/T value using a formula provided by Liquid Assets. Reading a textual log file generated by the weather station's provided software interfaces to the weather station. This log file is updated hourly by the weather station's provided software. Among other things, it contains ET and rainfall values, both in inches (not “inches per day” or “inches per hour”, just inches since the last log entry). Since ET values are available directly, no formula was required from Liquid Assets.

Once per day, at a time set on the Monitoring Station's “View/Edit Base Station” screen, the Base Station software generates a schedule. This schedule is based on a precipitation rate of 2 inches per hour for spray heads and 1 inch per hour for rotor heads. Note that the number of minutes generated by this routine must be consistent with the valve percentage calculated in ValveDetails.asp's CalcValvePercentage function. Refer to WaterFlowCalculator.cpp's CalculateNumberOfMinutes function for details.

The system 10 can be set up to interface with a Weather Station at regular intervals throughout the day and read current rainfall amounts. If the Station reports that rainfall is occurring and a configurable amount (in inches) has fallen since the rainfall started, send a “stop now” command to each satellite. That command halts the irrigation schedule for that day. Every 10 minutes, the weather station's data file is queried for additional information. Though the data file is only written to once per hour by the weather station's provided software, this mechanism allows for faster response times to rainfall in the future should the provided software change its behavior. Any new information, including rainfall, is written to the local Access database.

The amount of continuous rain is totaled at each point and if it exceeds the amount set on the Monitoring Station's “View/Edit Base Station” screen's “Max. Rainfall before Shutdown” field, all Satellites are sent a “Stop All Valves for a Satellite” command with the “T” option to terminate their schedules. Refer to WeatherStationInterface.cpp's PollWeatherFileData function for details.

Past data is recorded from the Weather Station. If any specific reading remains the same for three successive days, generate a warning and send it to the Monitoring Station during the next connection. WeatherStationInterface.cpp's VerifyWeatherStationValid function performs this task. It checks the following values from the weather station data:

WindSpeed

WindDirection

Temperature

WindChill

DewPoint

BarometricPressure

UVRadiation

RainFall

SolarRadiation

ET

All weather readings are stored in the local Access database's WeatherReading table and are requested by the Monitoring Station's Transfer.asp page for storage into the Monitoring Station's MySQL WeatherReading table.

In the event that no weather readings are available within the last 24 hours, an ETo value of 0.20 inches is used. This value was taken from Michigan estimates of spring, summer, and fall 2002 data as found on the Internet at http://emily.soils.wisc.edu/cgi-bin/aws/et_arch pl?Region=MI The broken link to the weather station is reported through the normal error reporting mechanism.

Given that water flow meters likely generate a pulse train whose frequency is an indication of water flow rate, one of the unused satellite pins would be connected to the water flow meter. Satellite code watches this pin for changes and periodically sends a message to the base station reporting on each satellite, how many pulses were observed, and the time period (preferably in seconds) that was used. The base station stores these readings in a new table whose values are sent to the monitoring station. The revised base station software that understands the new message from the satellites is also responsible for using SQL to automatically upgrade its database to include this new table. The revised base station software is sent using the automatic update feature. The reprogramming of the satellite is done in the field since a technician has to go to the unit to install the meter anyway.

Allow a configurable Irrigation Efficiency Number that is applied to the entire site's irrigation schedules. This number is a percentage by which all schedules are reduced. Additionally, each valve can be individually adjusted for irrigation efficiency. The Monitoring Station's “View/Edit Base Station” screen's “Irrigation Efficiency” value is used here. The standard minutes to run are first calculated from ET and rainfall numbers, then modified according to the following formula:

New Minutes=Minutes/(Efficiency/100)

Thus, if a site is only 50 percent efficient, the minutes are doubled to account for the site's inability to efficiently apply water. Likewise, setting efficiency to 200 percent would halve the watering. Note that these minutes are then adjusted by the individual satellites for each valve.

The ET value and required water flow rate are used to determine an appropriate watering duration for the following day through the use of calculation algorithms provided by Liquid Assets. The equation uses a water flow rate (in gallons per minute) that is configurable for each site.

The software looks at the sum of ET inches since the last schedule subtracts the sum of rainfall inches since the last schedule. This is a measure of the amount of water that left the soil and thus should be replaced. Note that only up to the last 2 days worth of ET and rainfall data is considered in order to avoid excessive watering. Once per day, at a time set on the Monitoring Station's “View/Edit Base Station” screen, the Base Station software generates a schedule. This schedule is based on a precipitation rate of 2 inches per hour for spray heads and 1 inch per hour for rotor heads. Note that the number of minutes generated by this routine must be consistent with the valve percentage calculated in ValveDetails.asp's CalcValvePercentage function.

Allow one or more weekly “black-out dates” during which no watering is performed, i.e., every Monday, every Tuesday and Thursday, etc. The calculation algorithm takes this “lost time” into account by increasing the duration on the available dates appropriately. The calculation algorithm takes the blackout days into account by counting how many days are blacked out then increasing the minutes to water according to the following formula:

New Minutes to Water=Minutes*(7/(7—# of Blackout Days))

The results of using this formula are shown below with a sample run time of 10 minutes. Note that this formula results in the same amount of water being applied for each week regardless of the number of blacked out days.

| | | | | | Updated |
|---|---|---|---|---|---|
| # of | # of | | Sample | Updated | Minutes |
| Blackout | Watering | Increase | Minutes | Minutes | Per |
| Days | Days | Factor | Per Day | Per Day | Week |
| 0 | 7 | 1 | 10 | 10 | 70 |
| 1 | 6 | 1.167 | 10 | 11.667 | 70 |
| 2 | 5 | 1.4 | 10 | 14 | 70 |
| 3 | 4 | 1.75 | 10 | 17.5 | 70 |
| 4 | 3 | 2.333 | 10 | 23.333 | 70 |
| 5 | 2 | 3.5 | 10 | 35 | 70 |
| 6 | 1 | 7 | 10 | 70 | 70 |

Specific yearly “black-out dates” can also be allowed, during which time no watering is done. These dates are not taken into account by the calculation algorithm. Daily “black-out times” during which no watering occurs can also be programmed. These times are settable in 1-hour increments during a 24-hour day. These times apply to each watering day. Note that these times are sent to the satellites along with the schedule and the satellites taken these blacked out hours into account when determining when to run their valves.

The Monitoring Station maintains a set of blackout dates, weekly blackout days, and daily blackout hours for each site. Each site may have different values for these, but there is only one set per site.

The Base Station software is a Windows “Service”, meaning it can run without user intervention and without a user even logging into the computer. It also automatically launches the Weather Station's interface program (which itself is not a service, but does not require human intervention in order to operate). All errors are recorded to a local Access database file that is later synchronized with the Monitoring Station.

The Monitoring Station's “View/Edit Base Station” screen's “Dialup Monitor 12 IP Address” is used to inform the Base Station of the Monitoring Station's location. However, during initial configuration, the Base Station must know about the Monitoring Station prior to connecting and receiving the update to this field. To support this, the Base Station reads an INI file named BaseStation.INI and reads the remote_monitor 12_address entry in the [Configuration Information] section. Also, since a locally connected Monitoring Station may not be reachable via the same IP as a remote station, BaseStation.INI has an entry called local_monitor 12_address that is used when working with a local Monitoring Station.

The system 10 can connect on a regular basis to the single Monitoring Station. The system 10 first connects via a local network connection, and if that fails, via a preconfigured and fully automated dial-up Internet connection. The connection frequency is configurable, and if it is unsuccessful, will retry each hour until a successful connection is established.

The default dialup Internet connection as setup through Microsoft's Internet Explorer is used for the dialup Internet connection. Upon startup, the Base Station attempts to connect with the Monitoring Station. After a successful connection, it waits a period of time set by the Monitoring Station's “View/Edit Base Station” screen's “Dialup Interval” field. If unsuccessful, the system 10 waits one hour before attempting to reconnect. Note that this wait is interrupted should the “connect now” command referred to in the next requirement by used.

The laptop computer should have installed a program file called BaseStationWakeUp.exe. When run on the laptop, this program reaches out to the local network and attempts to connect to a computer named “Lamsbasestation” (without the quotes of course). While this program is running successfully, the Base Station attempts a connection using the value in BaseStation.INI's local_monitor 12_address setting, and connects every 5 seconds.

The Base Station uses a local Access database to store all information queued for sending to the Monitoring Station. In this way, it can operate without the Monitoring Station being present and preserves unsent data even after being restarted.

The system 10 can automatically be deactivated if it is unable to establish a connection with the Monitoring Station for more than seven consecutive days. The deactivation sends a “deactivate” code to all Satellite Controller 14s. The MonitoringStationInterface.cpp file's PollForMonitor 12DisconnectedState function accomplishes this task. It checks the time and date of the most recent successful synchronization against the current time, and if more than the number of seconds in 7 days has elapsed, it initiates the sending of “Set Mode for a Satellite” messages to each Satellite to disable it. The routine also takes steps to ensure that upon the next connection to the Monitoring Station, that its updated status is sent before being overwritten with that of the Monitoring Station's.

Errors are stored within the Error table of the local Access database. The errors are sent during the next Monitoring Station connection.

Messages that generate a communication error are retried eight times at one-hour intervals then discarded after noting the error in the log. Messages that cannot be sent because Windows is temporarily rejecting the serial (RS-232) data are retried infinitely every one or five seconds depending upon whether connected locally to a Monitoring Station (one second if connected locally).

The system 10 can log and report any access of the Base Station back to the Monitoring Station during the next regular connection. This is to help identify any unauthorized use of the system 10 by the client. The Base Station has a thread that checks the system 10 every minute. During this check, it examines the titles of each window on screen. These titles are compared to a list of acceptable titles, as found in the local Access database's AllowedWindow table. Anything not found to be allowed results in an error being written to the error log.

The Monitoring Station's “Send Files to Base Station” screen is used to inform the Base Stations of new files they should download and install. To use this system 10, first establish an FTP site where files can be stored. This site can be password protected. Then, using an FTP program of one's choice, upload the new files to this site in the site's root directory. Next, use the “Send Files to Base Station” screen to give the name of the files and to inform one or all Base Stations. If the BaseStationService.exe program itself has been modified, it is necessary to also use the screen's “Restart Base Station(s)” button cause the new file to take effect. Any file in the same directory as the BaseStationService.exe program can be modified this way.

Once the Base Station gets notice of new files, it uses entries in the BaseStation.INI file to guide it to the proper FTP server, FTP user account, and FTP password so that it can download the files. Note that the BaseStation.INI file can be downloaded as well using this feature, should the FTP site ever be changed.

The system 10 can receive from each Base Station that contacts the current status of the station (active or deactivated), daily watering schedules, ET values, acknowledgements, problem reports, and other information as sent by the Base Stations. The Monitoring Station's web site contains a page called Transfer.asp that accomplishes all data interchange between the Base Stations and the Monitoring Station. This page transfers site information (including site status), daily watering schedules, ET values, acknowledgements, problem reports, and configuration information. Note that the Base Station contains special code to ensure that should it become deactivated, its deactivation status is sent to the Monitoring Station prior the Monitoring Station overwriting the status during the data transfer.

The system 10 can also track the last date and time of contact for each Base Station. The Monitoring Station's Transfer.asp page (which is used by the Base Stations to send data) tracks the last date and time of contact with each site. It updates the Site table's LastConnection field. It also adds entries to the ConnectionLog table whenever it has been one or more hours since the last time a given Base Station has connected. This avoids a flood of connection logs when Base Stations are connected locally, during which they connect several times each minute.

The system 10 can provide a report listing the ET values and calculated schedules for each Base Station for a specified date range. The Monitoring Station's “E/T and Water Schedule” report screen first prompts the user for a date range then uses the Crystal Reports file called ETWaterScheduleReport.rpt to show data from the MySQL Schedule table which includes the schedule's start time, duration (in minutes), and the summed ET inches that was used.

The system 10 can provide a report listing the last date and time of contact for each Base Station. The Monitoring Station's Transfer.asp page (which is used by the Base Stations to send data) tracks the last date and time of contact with each site. It updates the Site table's LastConnection field. It also adds entries to the ConnectionLog table whenever it has been one or more hours since the last time a given Base Station has connected. (This avoids a flood of connection logs when Base Stations are connected locally, during which they connect several times each minute.) Crystal Reports can be used to show the values from this table using the Crystal Report file called ContactReport.rpt. This report is shown on the Monitoring Station's “Contact Report” screen.

A report listing error information can also be retrieved from Base Stations. The Monitoring Station's “Error Report” screen uses the Crystal Reports file called ErrorReport.rpt to show the error log from all Base Stations as recorded in the MySQL Error table.

The system 10 can be run on a Windows 2000-based computer using Microsoft IIS and Microsoft SQL Server 2000. This computer is known as the Web Host computer. The Base Station software was developed using Microsoft's Visual C++6.0 and is a Windows service. The Monitoring Station web pages are ASP 2.0 and compatible with Microsoft IIS. Per contractual changes, MySQL is being used as the database server instead of SQL Server 2000. The system 10 also includes a feature for automatically updating the Base Station software remotely when next contacted by the Base Station.

This is redundant with Base Station requirement 31 that is being met.

The system 10 configures the satellite ID codes. Each satellite must be configured via the DIP switches to a unique number. Furthermore, one must be designated as the primary satellite that can be connected to the Base Station. This is done using switches 1-5 for the ID code (as described in the document Software Features List, section Satellite Controller 14s, item 2) and switch 6 as “on” for the primary satellite and “off” for all others.

The satellites can be placed into “installation mode” by pressing the “installation mode” button (on the prototype boards, these buttons are blue) once after the satellite has been powered on. Pressing the button a second time returns the satellite into regular operation mode.

When a satellite is in “installation mode” it continually sends out requests for any other satellite to acknowledge. Any active satellite in normal mode that receives an installation mode message responds with an acknowledgement. If the satellite in installation mode receives an acknowledgement, it toggles its on-board LED. That way, it is easy to tell if the satellite in installation mode is within range of another active satellite.

Satellites should be installed one at a time, beginning with those closest to the primary satellite (the one connected to the Base Station via serial). Place the primary satellite in the appropriate location and apply power. The software/firmware requirements of Satellite Controller 14s are as follows.

Allow the configuration of a Site-specific ID number for each Satellite Controller 14. Use the bank of 8 DIP switches designated “SW1”, setting its sub-switches (named “sw1”to “sw8”) as outlined below:

| Satellite # | SW1.sw1 | SW1.sw2 | SW1.sw3 | SW1.sw4 | SW1.sw5 |
|---|---|---|---|---|---|
| 0 | Off | Off | Off | Off | Off |
| 1 | Off | Off | Off | Off | On |
| 2 | Off | Off | Off | On | Off |
| 3 | Off | Off | Off | On | On |
| 4 | Off | Off | On | Off | Off |
| 5 | Off | Off | On | Off | On |
| 6 | Off | Off | On | On | Off |
| 7 | Off | Off | On | On | On |
| 8 | Off | On | Off | Off | Off |
| 9 | Off | On | Off | Off | On |
| 10 | Off | On | Off | On | Off |
| 11 | Off | On | Off | On | On |
| 12 | Off | On | On | Off | Off |
| 13 | Off | On | On | Off | On |
| 14 | Off | On | On | On | Off |
| 15 | Off | On | On | On | On |

Each schedule is applied only once if a new schedule is not received in 48 hour, attempt to send an error report to the Base Station. The nature of the scheduling algorithm is that it calculates the number of minutes remaining for each valve. As the valves are engaged, the time stored for each is decremented. A schedule is considered complete when each valve's remaining duration is zero or less. After a schedule has been completed, the satellite retains no knowledge of the original duration. Thus, it is impossible for a satellite to use a schedule twice. Refer to ValveControl's PollValves function.

The system 10 can function by activating only one irrigation valve at a time or it can activate multiple valves in sequence, one immediately after another. (See the ValveControl's SetEnabledValve function wherein only one valve can be enabled at a time.)

Further, the system 10 can accommodate the needs of “cycle soaking”. This means that any single valve will never be activated for more than 20 minutes at a time, with 20-minute breaks in between active cycles if needed. Schedules include a time to start for each individual valve and a duration remaining. Whenever a valve stops, its time to start again is computed to be at least 20 minutes from the current time. Refer to ValveControl.c's PollValves function and the #define MAX_VALVE_RUN_DURATION_MINUTES.

Individual satellites accommodate “black out days” by virtue of only using a schedule once and the fact that the base station doesn't calculate new schedules on blacked out days.

Individual satellites are aware of the blacked out hours. They are taken into account when calculating the duration to run a valve. Refer to the communications protocol and to ValveControl.c's PollValves function.

Each valve can be configured with regard to the type of head (spray or rotor). Watering duration for spray heads are automatically reduced to a certain percentage of the duration for rotary heads. This is cumulative with the landscape reduction, if any.

Each Satellite Controller 14 must support a “repair or winter” mode as follows: The Monitoring Station initiates a “repair or winter” order, which is relayed to the Satellites by the base station. When in this mode, the Satellites lights an indicator LED, shut off all valves, suspends all normal operations, and enables a button on the Satellite. A user can press the button to manually activate each valve in sequence. However, if a valve is left on for more than 20 minutes, it is automatically shut off. (Refer to the Monitoring Stations's “View/Edit Base Station” screen for the “All Repair/Winter Mode” button that initiates this mode.) The user should press the Red (PB1) button on the satellites when in this mode. The 20-minute maximum is taken into account. Refer to ValveControl.c's PollValves function and MAX_VALVE_RUN_DURATION_MINUTES #define for changing this value.

The system 10 uses a current detector to tell whether a given valve terminal, when activated, is actually connected to a functional valve. A report is sent to the base station when a valve that had been connected previously is no longer connected, or vice versa. The PIC chip's pin A0 is used to detect the current draw. The software currently considers a reading on this pin of ¼ full-scale to constitute acceptable current draw. Refer to ValveControl.c's IsValveCurrentDetected function for this determination. The Satellite tracks which valves were connected at each schedule and reports differences back to the base station using the “Valve Connection Change from Satellite” message. Refer to the file “Base Station and Satellite Protocol r3.doc” for more information on this protocol.

The system 10 can use a current detector to check each valve after it has been shut off to ensure that the valve did actually shut off. If it remains on, interrupt the power to all valves and report an error to the base station. The PIC chip's pin A0 is used to detect the current draw. The software currently considers a reading on this pin of ¼ full-scale to constitute acceptable current draw. Refer to ValveControl's IsValveCurrentDetected function for this determination. ValveControl's function PollValves checks the current draw after shutting down a valve and uses the “Valve Stuck from Satellite” message to convey a failure to the Base Station. Also, the Satellite disables the master power by bringing the TRIAC_ENAB (pin A3) high (since TRIAC_ENAB is active low).

Use a current detector to monitor 12 the status of a valve after it has been turned on to ensure that the valve is actually drawing current. If it is off or if it shuts off unexpectedly, shut off the valve and report an error to the Base Station. The PIC chip's pin A0 is used to detect the current draw. The software currently considers a reading on this pin of ¼ full-scale to constitute acceptable current draw. Refer to ValveControl's IsValveCurrentDetected function for this determination. ValveControl's TurnOnValve function checks the current draw after enabling a valve. ValveControl.c's TurnOffCurrentlyEnabledValve function checks the current draw when turning off a valve and flags an error if the valve was not drawing current before being shutdown. Both use the “Valve Stuck from Satellite” message to convey a failure to the Base Station. Also, the Satellite disables the master power by bringing the TRIAC_ENAB (pin A3) high (since TRIAC_ENAB is active low).

The system 10 includes an “installation mode” that can be activated manually. When in “installation mode” the Satellite pulses one frequency every five seconds, and will light the “repair or winter” LED when it detects an incoming signal at that same frequency. This mode is used during installation and disables all other features of the Satellite Controller 14 while in this mode. Installation Mode is activated using the Blue (PB2) button. The software clears the “repair or winter” LED, sends out a special “ping” RF message to any satellite that can hear it, and toggles the LED when it gets an RF response. It then continues from the point of sending the ping message and waiting for a response.

Installation Mode can be exited by pressing the Blue (PB2) button again at any time during the cycle. Note that entering Installation Mode automatically clears the active schedule on the satellite due to RAM constraints on the PIC chip.

The installation begins by verifying that both satellites are functioning. Power is then applied to the next satellite that is installed. The satellite being installed is held upright and physically close to the primary satellite (between 1′ and 6′away). The primary satellite is placed into “installation mode”. Its LED should flash on and off to show that it is within range and communicating with the second satellite.

If the LED does not flash, take the primary satellite out of installation mode. Ensure that both satellites are powered correctly and that only the primary and one other satellite are powered. Put the second satellite into installation mode, wait 2-3 seconds, and put it back in normal operation. Then repeat the above step.

The primary satellite is placed in normal mode, and the satellite being installed is placed into installation mode. The LED on the second satellite should begin to blink. Take the satellite out to its install location. If the LED continues to blink regularly, it is still within range of the primary satellite. Put the second satellite back into normal mode (the LED should stop blinking), remove power, and install the satellite. Re-verification of the installation can be performed after installation, but if this is done power to the satellite must be shut off when complete. These steps are repeated as necessary for the remaining satellites.

If a satellite is installed that is outside of range of the primary satellite, select another, closer satellite to be its parent. Shut off power to the primary satellite, and apply power to the parent satellite. Use the process described above to ensure that the new satellite and its parent are communicating. Then, install the new satellite just as you would if it was communicating directly with the primary satellite.

Note that the relationships of the satellites must be recorded, i.e., “satellite 4 is the parent of satellite 5 and 6”. Any satellite can have zero to 4 children. Satellites can be “chained”, i.e., “satellite 3 is the parent of satellite 4, which is the parent of satellite 5”.

Once all of the satellites have been installed, the list of parent/child relationships (if any were needed) is defined as the network layout.

Apply power to all satellites, one at a time. As each satellite is powered up, place it in installation mode briefly (2-3 seconds) and then back to normal operation mode. This ensures a good “start-up” state for the satellites.

### Example 3

INSTALLATIONMODE.C(ABRIDGED)

. . . . .

void PollForInstallationMode( )
{

int1 in_installation_mode;
in_installation_mode = PollForInstallationButtonPush( );
if(!in_installation_mode) {

return;

}
TurnOffDebugLED( );
ResetSchedule( );
. . . . .
while (in_installation_mode) {

// Send a ping
SendSmallMessage(SMALL_MESSAGE_TYPE_PING,

MESSAGE_DIRECTION_TOWARDS_CHILD_SATELLITES);

ResetSerialReceiver( );
// Wait for a response.
while (in_installation_mode) {

if(PollForRFPingReply( )) {

// Got Reply.
FlipDebugLED( );

. . . . .

break;

}
in_installation_mode = in_installation_mode &&

!PollForInstallationButtonPush( );
}

in_installation_mode = in_installation_mode &&

!PollForInstallationButtonPush( );

}
ResetSchedule( );
. . . . .

}

SCHEDULEBUILDER.CPP(ABRIDGED)

. . . . .

void ScheduleBuilder::PollForNewSchedule( )
{

. . . . .
if(!IsReadyForNewSchedule( )) {

return;

}
. . . . .

// - Build the schedule data.

ScheduleData schedule_data;
BuildCurrentSchedule(schedule_data);

// - Create the log entry

sql_stream.str(“”);
sql_stream << “INSERT INTO Schedule (SiteCode, StartDateTime, Duration,

ET” << endl

<< “) VALUES (” << endl
<< static_cast<const char

*>(SQLHelper::GetSQLString(LocalConfiguration::site_code.c_str( ), true)) <<
endl

<< “, Now” << endl
<< “, ” << static_cast<int>(schedule_data.minute_duration) << endl
<< “, ” << static_cast<double>(schedule_data.et) << endl
<< “)” << endl;

. . . . .

// - Build the blackout hours value

sql_stream.str(“”);
sql_stream << “SELECT * FROM HourlyBlackout”;
. . . . .
unsigned long black_out_hours = 0;
. . . . .

// - Queue commands to deliver the schedule to each and

every satellite.

. . . . .
sql_stream << “SELECT SatelliteCode FROM SatelliteConfig”;
. . . . .
while (!rs.IsEOF( )) {
. . . . .

sql_stream << “INSERT INTO OutboundCommand” << endl

<< “(SiteCode, StartTime, MessageType, TargetSatelliteID” <<

endl

<< “, BlackoutHours, MinuteDuration) VALUES (” << endl
<< static_cast<const char

*>(SQLHelper::GetSQLString(LocalConfiguration::site_code.c_str( ), true)) <<
endl

<< “, Now, ” << MESSAGE_SET_SCHEDULE << endl
<< “, ” << static_cast<int>(rs[“SatelliteCode”]) << endl
<< “, ” << black_out_hours << endl
<< “, ” << static_cast<int>(schedule _data.minute_duration)

<< endl

<< “)” << endl;

. . . . .
}
. . . . .

}
bool ScheduleBuilder::IsReadyForNewSchedule( )

// This checks many conditions:
// Checks if a schedule was created in the past day
// Checks if today is a “black out” day
// Checks if the site is deactivated
// Checks if the rainfall has exceeded the threshold for the day

{

. . . . .
if(rs.IsEOF( )) {

// Site record doesn't exist. Should only happen before initial

synchronization.

ErrorLogger::LogWithTimeAndEOL(“Site record doesn't exist. Should

only happen before initial synchronization.”);

return false;

}
if(rs[“MinuteDelta”].IsNull( )) {

// ScheduleUpdateInterval isn't set.
ErrorLogger::LogWithTimeAndEOL(“ScheduleUpdateInterval isn't

set.”);

return false;

}
int minutes_since_schedule_update = rs[“MinuteDelta”];
if((minutes_since_schedule_update < 0) | | (minutes_since_schedule_update.

> 60)) {

| | // It's not time. |
|---|---|
| // | ErrorLogger::LogWithTimeAndEOL(“It's not time to build |

schedule.”);

return false;

}
rs.Close( );
// Check for a schedule created during the current day
. . . . .
if(!rs.IsEOF( )) {

| | // Schedule exists. |
|---|---|
| // | ErrorLogger::LogWithTimeAndEOL(“Schedule already exists”); |
| | return false; |

}
rs.Close( );

// - Check if today is a blackout day.

// First check day of the week in DailyBlackout.
time_t current_time = time(NULL);
tm * time_info = localtime(&current_time);
sql_stream.str(“ ”);
sql_stream << “SELECT Day” << static_cast<int>(time_info->tm_wday + 1)

<< “AS CurrentDay” << endl

<< “FROM DailyBlackout” << endl;

. . . . .
if(rs.IsEOF( )) {

current_day_is_blacked_out = 0;

} else {

current_day_is_blacked_out = rs[“CurrentDay”];

}
. . . . .
// Check date in GrandBlackout
. . . . .
sql_stream << “SELECT StartDateTime FROM GrandBlackout” << endl

<< “WHERE Now( ) >= StartDateTime” << endl
<< “AND Now( ) <= EndDateTime”;

. . . . .
if(!rs.IsEOF( )) {

current_day_is_blacked_out = 1;

}
. . . . .
if(current_day_is_blacked_out) {

| | |
|---|---|
| // | ErrorLogger::LogWithTimeAndEOL(“Don't build schedule since current |

day is blacked out.”);

return false;

}

// - Check if site is deactivated

. . . . .
if(!rs.IsEOF( )) {

CString status = rs[“Status”];
if(status == SITE_STATUS_INACTIVE) {

| | |
|---|---|
| // | ErrorLogger::LogWithTimeAndEOL(“Don't build schedule since |

site is deactivated.”);

return false;

}

}
. . . . .
if(WeatherStationInterface::HasExceededRainFallThresholdToday( )) {

ErrorLogger::LogWithTimeAndEOL(“Don't build schedule since site

has exceeded daily rainfall.”);

return false;

}
. . . . .

}
void ScheduleBuilder::BuildCurrentSchedule(ScheduleData& out_schedule)
{

out_schedule.et = 0;
out_schedule.minute_duration = 0;
double irrigation_efficiency = 0;
double sum_of_et_inches_since_last_watering = 0;
double sum_of_rainfall_inches_since_last_watering = 0;
. . . . .
if(rs.IsEOF( )) {

// There are no recent WeatherReading records to build the

schedule with.

// Report the error and setup to use a default ET value.

ErrorLogger::LogErrorToDatabase(DATABASE_ERROR_MISSING_WEATHER_STATION_R

EADINGS, NULL);

rs.Close( );
// Use default ET and rainfall values
sum_of_et_inches_since_last_watering = 0.20;

// NOTE: ETo value estimate of inches/day taken from
// ----- Michigan estimates for spring-summer-fall 2002
// as found at http://emily.soils.wisc.edu/cgi-

bin/aws/et_arch.pl?Region=MI

sum_of_rainfall_inches_since_last_watering = 0;

} else {
. . . . .

// Get the rainfall and water lost since the last watering
// or at most during the last 2 days.

. . . . .

sql_stream << “SELECT SUM(ET) AS SumET,SUM(Rainfall) AS

SumRainfall” << endl

<< “FROM WeatherReading” << endl
<< “WHERE ((SELECT MAX(CreateDatetime) FROM Schedule)

IS NULL OR CreateDatetime > (SELECT MAX(CreateDatetime) FROM Schedule))” <<
endl

<< “AND CreateDatetime >= DateAdd(‘d’,−2,Now( ))” <<

endl;

rs.Open(CQueryDef::forwardOnly, sql_stream.str( ).c_str( ));
if(!rs.IsEOF( )) {

out_schedule.et = rs[“SumET”];
sum_of_et_inches_since_last_watering = rs[“SumET”];
sum_of_rainfall_inches_since_last_watering =

rs[“SumRainfall”];

}

. . . . .
}
double minutes = WaterFlowCalculator::CalculateNumberOfMinutes(
sum_of_et_inches_since_last_watering,sum_of_rainfall_inches_since_last_w

atering);

. . . . .
irrigation_efficiency = rs[“IrrigationEfficiency”];
irrigation_efficiency /= 100.0; // convert from integer percent to

fraction

. . . . .
// This is the site's irrigation efficiency. Valves have a similar value

but this is applied else where.

if(irrigation_efficiency > 0) {

minutes /= irrigation_efficiency;

}
// Scale the number of minutes based on the number of days blacked out.
. . . . .
int num_blacked_out_days = 0;
. . . . .
if(num_blacked_out_days < 7) {

minutes *= 7.0f / (7.0f - num_blacked_out_days);

}
if(minutes > 0xFF) {

out_schedule.minute_duration = 0xFF;

} else if(minutes > 0 && minutes <= 1) {

// Round up for 1 minute and under
out_schedule.minute_duration = 1;

} else if(minutes > 1) {

// Do normal rounding for anything > 1 mintue
out_schedule.minute_duration = static_cast<int>(minutes + 0.5);

} else {

out_schedule.minute_duration = 0;

}

}

VALVECONTROL.C(ABRIDGED)

| | |
|---|---|
| #define MAX_VALVE_RUN_DURATION_MINUTES | (20) |

// The length of time a valve is allowed to run. Used for Cycle

Soaking purposes.

| | |
|---|---|
| #define SHUTOFF_WINDOW_MINUTES_DURATION | (20) |

// The length of time a valve is guaranteed to be turned off for

Cycle Soaking purposes.
bool IsValveCurrentDetected(int1 debug_hint)

// Returns true if enough current is detected to indicate that a valve
// is enabled. debug_hint is returned under development conditions to
// simulate success conditions.
//
// Avoiding typedef in prototype to avoid compiler flaw.

{

. . . . . .
// This assumes an 8-bit A/D.
return read_adc( ) >= 0x40;

}
void TurnOffCurrentlyEnabledValve( )

// Turn off the valve that is currently on. If feedback current is not
// detected, flag the valve as disconnected. Sets the shutoff window.

{

if(!IsValveCurrentDetected(true)) {

// The valve should be on. If not it has unexpectedly

disconnected.

write_eeprom(EEPROM_ADDR_VALVE_STATUS + active_valve_id,

read_eeprom(EEPROM_ADDR_VALVE_STATUS + active_valve_id) &

˜(1 << VALVE_STATUS_BIT_ACTIVE));

}
. . . . . .
SetEnabledValve(VALVE_DISABLE);
is_valve_active = false;
// Start the shutoff window.
write_eeprom_16(EEPROM_ADDR_VALVE_AVAILABLE_TIMES + active_valve_id *

sizeof(int16),

GetFutureSecondOfDay(SHUTOFF_WINDOW_MINUTES_DURATION * 60));

}
void SetEnabledValve(int8 valve)

// valve: This is a 0-indexed version of the labels on the PCB. This is

inversed

| // from the pin load order. | |
|---|---|
| // | 0−(MAX_VALVES − 1): Turn on the specified valve. |
| // | VALVE_DISABLE: Turn off all valves. |

{

. . . . .
for(i = 0; i < MAX_VALVES; i++) {

if ((MAX_VALVES − 1 − valve) == i) {

. . . . . Turn valve ON

} else {

. . . . . Turn valve OFF

}

. . . . .
}
. . . . .
if(valve == VALVE_DISABLE) {

output_high(PIN_TRIAC_ENABLE);

} else {

output_low(PIN_TRIAC_ENABLE);

}

}
#separate void TurnOnValve(int8 new_valve_index, int8 minutes)

// This calls SetEnabledValve internally. This does some higher level

book keeping,

// sets a shut off time, and performs error handling.

{

SetEnabledValve(new_valve_index);
. . . . .
if(IsValveCurrentDetected(true)) {

// Mark the valve as connected
write_eeprom(EEPROM_ADDR_VALVE_STATUS + new_valve_index,

read_eeprom(EEPROM_ADDR_VALVE_STATUS + new_valve_index) | (1

<< VALVE_STATUS_BIT_ACTIVE));

. . . . .

valve_scheduled_shut_off_seconds = GetSecondTimestamp( ) + (minutes

* 60);

. . . . .
} else {
. . . . .

// Mark the valve as disconnected
write_eeprom(EEPROM_ADDR_VALVE_STATUS + new_valve_index,

read_eeprom(EEPROM_ADDR_VALVE_STATUS + new_valve_index) &

˜(1 << VALVE_STATUS_BIT_ACTIVE));

SetEnabledValve(VALVE_DISABLE);

}

}
#separate void PollValves( )
{

. . . . .
// Do not attempt valve control until the local time has been

set/calibrated.

if(!IsTimeCalibrated( )) {

return;

}
. . . . .
if(is_valve_active) {

if(HasSecondPassed(valve_scheduled_shut_off_seconds)) {

. . . . .

TurnOffCurrentlyEnabledValve( );
if(current_mode == MODE_NORMAL) {

. . . . .

if(IsValveCurrentDetected(false)) {

// Valve is stuck ON. Flag this for base station

notification.

// Flag stuck valve
write_eeprom(EEPROM_ADDR_VALVE_STATUS +

active_valve_id,

read_eeprom(EEPROM_ADDR_VALVE_STATUS +

active_valve_id) | (1 << VALVE_STATUS_BIT_UNREPORTED_STUCK));

// Stop the current schedule.

. . . . .

}
// Is schedule complete?
complete = true;
for(i = 0; i < MAX_VALVES; i++) {

if(read_eeprom(EEPROM_ADDR_VALVE_DURATIONS + i)

> 0) {

complete = false;
break;

}

}
if(complete) {

. . . . .

// Flag that a completion message should be

sent.

. . . . .

}

}

. . . . .

}

} else if(is_schedule_active) {

// Check for next available valve.
int8 max_minutes;
// max_minutes = min(max_minutes_to_blackout, duration_left,

MAX_VALVE_RUN_DURATION_MINUTES)

if(IsHourBlackedOut(current_time / 60)) {

// Currently in a blackout hour.
max_minutes = 0;

} else if(IsHourBlackedOut((current_time / 60) + 1)) {

// The next hour is a blackout hour
max_minutes = 60 − (current_time % 60);
if(max_minutes > MAX_VALVE_RUN_DURATION_MINUTES) {

max_minutes = MAX_VALVE_RUN_DURATION_MINUTES;

}

} else {

// The current hour and next are not black outs.
max_minutes = MAX_VALVE_RUN_DURATION_MINUTES;

}
if(max_minutes > 0) {

. . . . .

do {

. . . . .

// If this valve is not within the “wait after soak”

time, and there

// are minutes left to soak, turn on.
if(read_eeprom_16(EEPROM_ADDR_VALVE_AVAILABLE_TIMES +

i * sizeof(int16)) << INVALID_SECOND_OF_DAY VALUE) {

// Not in the post soak wait time.

. . . . .

valve_minutes_left =

read_eeprom(EEPROM_ADDR_VALVE_DURATIONS + i);

. . . . .

if(valve_minutes_left > 0) {

// This valve is ready to be started.
if(valve_minutes_left < max_minutes) {

max_minutes = valve_minutes_left;

}
write_eeprom(EEPROM_ADDR_VALVE_DURATIONS +

i, valve_minutes_left − max_minutes);

TurnOnValve(i, max_minutes);
break;

}

}

} while(i != active_valve_id);

}

. . . . .
} else if(current_mode == MODE_NORMAL) {

// The schedule isn't active and the satellite is in normal mode.
// Start the schedule if it is time or if the repair/winter button

is pressed.

if(HasMinuteOfDayPassed(read_eeprom_16(EEPROM_ADDR_SCHEDULE_START),

SCHEDULE_START_WINDOW_MINUTES, false) ||

PollForStartScheduleButtonPush( )) {

// Start the schedule. First reset the schedule start time

so that the same schedule

// is never started again.

. . . . .

write_eeprom_16(EEPROM_ADDR_SCHEDULE_START,

INVALID_MINUTE_VALUE);

for(i = 0; i < MAX_VALVES; i++) {

. . . . .

write_eeprom(EEPROM_ADDR_VALVE_DURATIONS + i,

((int16)read_eeprom(EEPROM_ADDR_VALVE_PERCENTAGES + i)) *
((int16)read_eeprom(EEPROM_ADDR_SCHEDULE_DURATION)) / 100);

}

. . . . .

}

}
if((current_mode == MODE_REPAIR_WINTER) && PollForRedButtonPush( )) {

// Advance to the next valve.
// Don't check for stuck or disconnected valves.
active_valve_id = (active_valve_id + 1) % MAX_VALVES;
SetEnabledValve(active_valve_id);

. . . . .

valve_scheduled_shut_off_seconds = GetSecondTimestamp( ) +

(MAX_VALVE_RUN_DURATION_MINUTES * 60);

}

}
#separate bool HandleSetModeMessage( )
{

. . . . .
current_mode = read_eeprom(EEPROM_ADDR_SATELLITE_MODE);
if(current_mode == MODE_DEACTIVATED) {
if(DecodeASCII8(&primary_message_buffer[SET_SATELLITE_OFFSET_MODE]) ==

MODE_REACTIVATED) {

current_mode = MODE_NORMAL;

}

} else {

switch

(DecodeASCII8(&primary_message_buffer [SET_SATELLITE_OFFSET_MODE])) {

case MODE_NORMAL:

. . . . .

current_mode = MODE_NORMAL;
TurnOffDebugLED( );
break;

case MODE_REPAIR_WINTER:

. . . . .

ResetSchedule( );
current_mode = MODE_REPAIR_WINTER;
active_valve_id = 0xFF; // force start at first valve

when the button is pressed

TurnOnDebugLED( );
break;

case MODE_DEACTIVATED:

ResetSchedule( );
current_mode = MODE_DEACTIVATED;
TurnOffDebugLED( );
break;

default:

return false;

}

}
write_eeprom(EEPROM_ADDR_SATELLITE_MODE, current_mode);
return true;

}

VALVEDETAILS.ASP (ABRIDGED)
' This takes a a recordset object opened to a ValveConfig record.
' This function doesn't account for the site's IrrigationEfficiency.
' Returns 0-255, with 100 representing “100% of the watering schedule's time
on this valve”
' and 50 representing “50% of the watering schedule's time on this valve”
Function CalcValvePercentage(rs)

Const SPRAY_HEADS_INCHES_PER_HOUR = 2.0
Const ROTOR_HEADS_INCHES_PER_HOUR = 1.0
Const TURF_Kc = 0.7
Const LANDSCAPING_Kc = 0.8
' Const values can't be defined in terms of another const.
Dim BASELINE_INCHES_PER_HOUR
BASELINE_INCHES_PER_HOUR = SPRAY_HEADS_INCHES_PER_HOUR
Dim BASELINE_Kc
BASELINE_Kc = TURF_Kc
CalcValvePercentage = 100
' These constants are arbitrary and will likely need to be changed.
Select Case atoi(rs(“ValveType”))

Case VT_SPRAY:

CalcValvePercentage = CalcValvePercentage *

(SPRAY_HEADS_INCHES_PER_HOUR/BASELINE_INCHES_PER_HOUR)

Case VT_ROTOR:

CalcValvePercentage = CalcValvePercentage *

(ROTOR_HEADS_INCHES_PER_HOUR/BASELINE_INCHES_PER_HOUR)

End Select
Select Case atoi(rs(“LocationType”))

Case VLT_LANDSCAPING:

CalcValvePercentage = CalcValvePercentage *

(LANDSCAPING_Kc/BASELINE_Kc)

Case VLT_TURF:

CalcValvePercentage = CalcValvePercentage *

(TURF_Kc/BASELINE_Kc)

End Select
if atoi(rs(“IrrigationEfficiency”)) <> 0 Then

CalcValvePercentage = 100.0*(CalcValvePercentage /

atoi(rs(“IrrigationEfficiency”)))

End If
CalcValvePercentage = atoi(CalcValvePercentage)
If CalcValvePercentage < 0 Then

CalcValvePercentage = 0

ElseIf CalcValvePercentage > 255 Then

CalcValvePercentage = 255

End If

End Function

WATERFLOWCALCULATOR.CPP (ABRIDGED)
. . . . .
#define SPRAY_HEADS_INCHES_PER_HOUR (2.0)
#define ROTOR_HEADS_INCHES_PER_HOUR (1.0)
#define TURF_Kc (0.7)
#define LANDSCAPE_Kc (0.8)
#define BASELINE_INCHES_PER_HOUR (SPRAY_HEADS_INCHES_PER_HOUR)
#define BASELINE_Kc (TURF_Kc)
double WaterFlowCalculator::CalculateNumberOfMinutes(

double sum_of_et_inches_since_last_watering,
double sum_of_rainfall_inches_since_last_watering)

{

if(sum_of_rainfall_inches_since_last_watering <= 0) {

sum_of_rainfall_inches_since_last_watering = 0;

}
double inches_of_water_needed = sum_of_et_inches_since_last_watering

- sum_of_rainfall_inches_since_last_watering;

// NOTE: Don't factor in the amount of water put in last time since that
// ----- water was used to replace previous water.

if(inches_of_water_needed <= 0) {
. . . . .

return 0;

}
double minutes = inches_of_water_needed / BASELINE_INCHES_PER_HOUR *

60.0;

// Units Check: inches * (hour/inch) * (minutes/hour) = minutes

. . . . .
return minutes;

}

WEATHERSTATIONINTERFACE.CPP (ABRIDGED)
. . . . .
double WeatherStationInterface::max_rainfall_per_Day = −1;
bool WeatherStationInterface::PollWeatherFileData( )

// Polls the weather data file and creates new WeatherReading records

with it.
{

// parsed version of the text log that the weather software creates.
WeatherStationLog weather_log;
if(!weather_log.ParseFrom(LocalConfiguration::weather_log_file.c_str( )))

{

ErrorLogger::LogWithTimeAndEOL(“Failed to read weather file log”,

_FILE_, _LINE_);

return true;

}
if(!weather_log.GetNumRows( )) {

return true;

}
. . . . .
bool already_exceeded_daily_rain_fall_threshold =

HasExceededRainFallThresholdToday( );

. . . . .
int num_rows = weather_log.GetNumRows( );
{for(int iter_row = 0; iter_row < weather_log.GetNumRows( ); iter_row++)

{

string date_text = weather_log.GetColumn(iter_row,

WEATHER_COLUMN_DATE);

string time_text = weather_log.GetColumn(iter_row,

WEATHER_COLUMN_TIME);

COleDateTime weather_datetime;
if(!ParseDateTime(weather_datetime, date_text, time_text)) {

ErrorLogger::LogWithTimeAndEOL(“Failed to parse date from

weather file log”, _FILE_, _LINE_);

return false;

}
if(has_max_recorded_date_time && (weather_datetime <=

max_recorded_date_time)) {

continue;

}

. . . . .

rs.AddNew( );
rs[“SiteCode”] = LocalConfiguration::site_code.c_str( );
rs[“CreateDateTime”] = weather_datetime;

. . . . .

rs[“WindDirection”] = direction_string.c_str( );

. . . . .

SetNumericDatabaseField(rs, “Temperature”,

weather_log.GetColumn(iter_row, WEATHER_COLUMN_OUTSIDE_TEMPERATURE));

SetNumericDatabaseField(rs, “WindChill”,

weather_log.GetColumn(iter_row, WEATHER_COLUMN_WIND_CHILL));

SetNumericDatabaseField(rs, “DewPoint”,

weather_log.GetColumn(iter_row, WEATHER_COLUMN_DEW_PT));

SetNumericDatabaseField(rs, “BarometricPressure”,

weather_log.GetColumn(iter_row, WEATHER_COLUMN_BAR));

| | |
|---|---|
| // | SetNumericDatabaseField(rs, “UVRadiation”, |

weather_log.GetColumn(iter_row,));

SetNumericDatabaseField(rs, “RainFall”,

weather_log.GetColumn(iter_row, WEATHER_COLUMN_RAIN));

SetNumericDatabaseField(rs, “SolarRadiation”,

weather_log.GetColumn(iter_row, WEATHER_COLUMN_SOLAR_RADIATION));

SetNumericDatabaseField(rs, “ET”,

weather_log.GetColumn(iter_row, WEATHER_COLUMN_ET));

rs.Update( );

. . . . .
}}
if(!already_exceeded_daily_rain_fall_threshold &&

HasExceededRainFallThresholdToday( )) {

// The readings that have just been read in have crossed the rain

fall threshold.

// Tell all satellites to stop watering *AND* kill the schedule

for the day

. . . . .

CString satellite_code = rs[“SatelliteCode”];
sql_stream.str(“”);
sql_stream << “INSERT INTO OutboundCommand” << endl

<< “(SiteCode, MessageType, StopValvesFlag,

TargetSatelliteID) VALUES” << endl

<< “(” << static_cast<const char

*>(SQLHelper::GetSQLString(LocalConfiguration::site_code.c_str( ), true)) <<
endl

<< “,” << MESSAGE_STOP_ALL_VALVES << endl
<< “, ‘T’” << endl
<< “,” << static_cast<const char

*>(SQLHelper::GetSQLString(satellite_code, true)) << endl

<< “)” << endl;

. . . . .
}
return true;

}
void WeatherStationInterface::VerifyWeatherStationValid( )

// Scans for lack of log entries and for “stuck” weather readings.

{

// Only check (and potentially log errors) once a day.
if (!StatusMgr::CheckDateDiff(“LastWeatherStatusCheck”, “h”, 24 * 1,

true)) {

return;

}
. . . . .
if(rs[“EarliestReading”].IsNull( )) {

// There are no readings. There are three scenarios:
// A) The station was never set up correctly and never

read a single reading.

// B) The station is set up correctly and has yet to take

the first reading.

// C) The station broke a long time ago and has flushed

all relevant logs. MANY error

// logs will have been made by this point.
//
// None of these scenarios needs to generate error logs.
return;

}
. . . . .
if(span_since_earliest_recording.GetTotalHours( ) < (24 * 3)) {

// There are a small number of logs that don't span enough time to

detect error conditions.

return;

}
. . . . .
sql_stream << “SELECT COUNT(*) AS ReadingCount FROM WeatherReading” <<

endl

<< “WHERE DateDiff(‘h’, CreateDateTime, Now( ) < (24 * 3))”;

. . . . .
int recent_readings_count = rs[“ReadingCount”];
. . . . .
// If there have been at least three days of total readings and there

are less than two days worth

// of readings in the past three days, report missing readings.
if(recent_readings_count < (48*2)) {

ostringstream error_stream;
error_stream << “Only” << recent_readings_count << “ weather

readings have occurred in the past 72 hours”;

ErrorLogger::LogErrorToDatabase(DATABASE_ERROR_MISSING_WEATHER_STATION_R

EADINGS,

error_stream.str( ).c_str( ), _FILE_, _LINE_);

return;

}
. . . . .
sql_stream << “SELECT * FROM WeatherReading” << endl

<< “WHERE DateDiff(‘h’, CreateDateTime, Now( )) < (24 * 3)”;

. . . . .
const char * compare_weather_columns[] =
{

“WindSpeed”,
“WindDirection”,
“Temperature”,
“WindChill”,
“DewPoint”,
“BarometricPressure”,
“UVRadiation”,
“RainFall”,
“SolarRadiation”,
“ET”

};
. . . . .
{for(int i = 0; i < sizeof(compare_weather_columns) /

sizeof(compare_weather_columns[0]); i++) {

do_values_vary[i] = false;

}}
. . . . .
{for(int i = 0; i < sizeof(compare_weather_columns) /

sizeof(compare_weather_columns[0]); i++) {

if(!do_values_vary[i]) {

if(!is_value_stuck) {

stuck_error_message << “Weather Reading stuck:”;
is_value_stuck = true;

} else {

stuck_error_message << “,”;

}
stuck_error_message << compare_weather_columns[i];

}

}}
if(is_value_stuck) {
ErrorLogger::LogErrorToDatabase(DATABASE_ERROR_STUCK_WEATHER_STATION_REA

DING,

stuck_error_message.str( ).c_str( ));

}

}
double WeatherStationInterface::GetLargestContiguousRainFallSumForToday( )

// Gets the largest contiguous run of rain fall that occurred today.
// Example: 0, 5, 3, 2, 0, 0, 0, 1, 1, 0, 4, 4
// Would return 10 (for the 5, 3, 2 run)

{

. . . . .
return largest_rain_fall_run;

}
bool WeatherStationInterface::HasExceededRainFallThresholdToday( )
{

if(max_rainfall_per_day > 0) {

return GetLargestContiguousRainFallSumForToday( ) >=

max_rainfall_per_day;

} else {

return false;

}

}

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

What is claimed is:

1. A system for controlling an irrigation system comprising:
monitoring means for remotely monitoring and communicating irrigation related information in the system;
controlling means in communication with said monitoring means for receiving said information, processing said information to coding functional commands, and sending said information to the irrigation system;
a weather station in communication with said controlling means for reporting and monitoring weather related information; and
decoding means in communication with said controlling means for decoding the coded signal at specific sites in the irrigation system and performing a function based upon the signal.

2. The system according to claim 1, wherein said weather station is a weather service that provides the irrigation related information on a predetermined basis.

3. The system according to claim 2, wherein the irrigation related information is selected from the group consisting essentially of rainfall, wind conditions, sun, humidity, and temperature.

4. The system according to claim 1, wherein said controlling means is a base station placed at the location of irrigation needs.

5. The system according to claim 4, wherein said base station is a CPU that can be accessed remotely and at the site of irrigation.

6. The system according to claim 1, wherein said decoding means is at least one satellite.

7. The system according to claim 6, wherein said satellite is operatively connected to valves of the irrigation system, whereby said satellite is capable of opening or closing the valves upon receipt of an appropriate signal.

8. The system according to claim 1, wherein said remote access is selected from the group consisting essentially of an external communication system, an internal communication system, local area network, wide area network, direct cable connection, wireless connection, and radio communication.

9. The system according to claim 8, wherein said remote access includes security means.

10. The system according to claim 9, wherein said security means is selected from the group consisting essentially of a PIN, an access code, a password, and a URL with an identification number.

11. A method of remotely controlling an irrigation system by:
providing the system with irrigation related information; and
remotely modulating the system based upon the irrigation related information.

12. The method according to claim 11, wherein said remotely modulating step includes controlling the system's function based upon the need for water.

13. The method according to claim 11, further including monitoring fluid flow through the system to monitor for leaks.

14. The method according to claim 11, wherein said remotely modulating step includes remotely accessing the system via a communication system selected from the group consisting essentially of an external communication system, an internal communication system, local area network, wide area network, direct cable connection, wireless connection, and radio communication.

15. The method according to claim 14, further including a securing step for remotely securing access to the system.

16. The method according to claim 15, wherein said securing step includes inputting an identifier selected from the group consisting essentially of a PIN, an access code, a password, and a URL with an identification number for remotely securing access to the system.

17. An algorithm for performing the method of claim 11.

18. A software program for controlling an irrigation system, said program comprising:
a CPU for running the program;
an algorithm for controlling the irrigation system.
